(19) United States
(12) Patent Application Publication
(10) Pub. No.: US 2025/0165024 A1
(43) Pub. Date: May 22, 2025

(54) PEDAL DEVICE

(71) Applicant: DENSO CORPORATION, Kariya-city (JP)

(72) Inventor: YUKI MATSUNAGA, Kariya-city (JP)

(21) Appl. No.: 19/028,753

(22) Filed: Jan. 17, 2025

Related U.S. Application Data
(63) Continuation of application No. PCT/JP2023/033788, filed on Sep. 15, 2023.

(30) Foreign Application Priority Data
Sep. 26, 2022 (JP) 2022-152819

(51) Int. Cl. G05G 5/03; B60T 7/04; B60T 7/06; G05G 1/38; G05G 1/42; G05G 5/05

(52) U.S. Cl. CPC G05G 5/03; G05G 1/42; G05G 5/05; B60T 7/042; B60T 7/06; G05G 1/38; G05G 2505/00

(57) ABSTRACT

A pedal device includes a pedal, a holder and at least one elastic member. The holder is configured to be displaceable in a predetermined direction by receiving, from one side in the predetermined direction, a force that is applied by the pedal associated with displacement of the pedal. The at least one elastic member supports the holder from the other side in the predetermined direction, and receives the force applied by the pedal from the one side in the predetermined direction via the holder, so as to be elastically deformed and to apply an elastic force to the holder. The holder includes at least one passage that allows foreign matter to pass.

### CROSS REFERENCE TO RELATED APPLICATION

The present application is a continuation application of International Patent Application No. PCT/JP2023/033788 filed on Sep. 15, 2023, which designated the U.S. and claims the benefit of priority from Japanese Patent Application No. 2022-152819 filed on Sep. 26, 2022. The entire disclosures of all of the above applications are incorporated herein by reference.

### TECHNICAL FIELD

The present disclosure relates to a pedal device.

### BACKGROUND

Conventionally, a pedal device includes a pedal that is depressed by a driver to rotate, and a reaction force generator that generates a reaction force against a rotational force applied by the pedal as the pedal rotates.

### SUMMARY

According to an aspect of the present disclosure, a pedal device includes: a pedal; a holder configured to be displaceable in a predetermined direction by receiving, from one side in the predetermined direction, a force that is applied by the pedal associated with a displacement of the pedal; and at least one elastic member configured to support the holder from the other side in the predetermined direction. In the pedal device, the elastic member may be configured to receive the force applied by the pedal from the one side in the predetermined direction via the holder, to be elastically deformed and to apply an elastic force to the holder. In addition, the holder may include at least one passage that allows foreign matter to pass.

According to another aspect of the present disclosure, a pedal device may includes: a pedal; a holder configured to be displaceable in a predetermined direction by receiving, from one side in the predetermined direction, a force that is applied by the pedal associated with a displacement of the pedal; and at least one elastic member that is supported by the holder from the other side in the predetermined direction, and is configured to receive a force applied by the pedal from the one side in the predetermined direction, to be elastically deformed and to apply an elastic force to the holder. In the pedal device, the holder may include a support that supports the elastic member from the other side in the predetermined direction, and the support may include at least one passage that allows foreign matter to pass.

According to an another aspect of the present disclosure, a pedal device includes: a pedal; a holder configured to be displaceable in a predetermined direction by receiving, from one side in the predetermined direction, a force that is applied by the pedal associated with a displacement of the pedal; at least one elastic member that supports the holder from the other side in the predetermined direction, and receives a force applied by the pedal from the one side in the predetermined direction via the holder to be elastically deformed and to apply an elastic force to the holder; and a guide portion configured to guide the holder to be displaceable in the predetermined direction. In the pedal device, the guide portion may include a passage that allows foreign matter to pass.

According to an another aspect of the present disclosure, a pedal device includes: a pedal; an elastic member that is elastically deformed by a force applied by the pedal associated with a displacement of the pedal, to apply an elastic force to the pedal; and a housing that forms an accommodation chamber in which the elastic member is accommodated. In the pedal device, the housing may include at least one passage that allows foreign matter to pass from the accommodation chamber to an outside of the housing.

According to another aspect of the present disclosure, a pedal device includes: a pedal; an elastic member that is elastically deformed by a force applied by the pedal associated with displacement of the pedal, to apply an elastic force to the pedal as a reaction force against the force; and a housing that defines an accommodation chamber in which the elastic member is accommodated. In the pedal device, the elastic member may be supported by the housing while being accommodated in the accommodation chamber and may include at least one passage that allows foreign matter to pass from an inside of the accommodation chamber to an outside of the accommodation chamber.

According to another aspect of the present disclosure, a pedal device includes: a pedal; an elastic member that is elastically deformed by a force applied by the pedal associated with a displacement of the pedal, to apply an elastic force to the pedal; and a housing that defines an accommodation chamber in which the elastic member is accommodated. In the pedal device, the elastic member may be supported by the housing while being accommodated in the accommodation chamber, and the housing may include at least one passage that allows foreign matter to pass from an inside of the accommodation chamber to an outside of the accommodation chamber.

According to another aspect of the present disclosure, a pedal device includes: a pedal; an elastic member that is elastically deformed by a force applied by the pedal associated with displacement of the pedal, to apply an elastic force to the pedal as a reaction force against the force; and a housing that defines an accommodation chamber in which the elastic member is accommodated. In the pedal device, the elastic member may be supported by the housing while being accommodated in the accommodation chamber, and the elastic member may be provided with at least one passage that is provided to penetrate the elastic member and to allow foreign matter to pass.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic view illustrating a state where a brake-by-wire system, to which a pedal device according to a first embodiment is applied, is installed in a vehicle, and is a view used to assist in the explanation of the brake-by-wire system;

FIG. 2 is a view illustrating a cross-sectional configuration of the pedal device according to the first embodiment, which is a view to assist in the explanation of an elastic member, a holder, a housing, and a passage in the reaction force generator in the pedal device;

FIG. 3 is an enlarged cross-sectional view of a reaction force generator and its periphery in the pedal device according to the first embodiment of FIG. 2, which is a view to assist in the explanation of details of a holder and the like in the reaction force generator;

FIG. 4 is a view of the bottom of the holder of the pedal device according to the first embodiment of FIG. 2 as seen from the other side in the axial direction, which is a view to assist in the explanation of a plurality of passages provided at the bottom of the holder;

FIG. 5 is a view illustrating a cross-sectional configuration of a pedal device according to a second embodiment, which is a view to assist in the explanation of an elastic member, a holder, a housing, and a passage in the reaction force generator in the pedal device;

FIG. 6 is a view illustrating a cross-sectional configuration of a pedal device according to a third embodiment, which is a view to assist in the explanation of an elastic member, a holder, a housing, and a passage in the reaction force generator in the pedal device;

FIG. 7 is a view of the bottom of a holder of a reaction force generator in a pedal device according to a fourth embodiment as seen from the other side in the axial direction, which is a view to assist in the explanation of a plurality of passages provided at the bottom of the holder;

FIG. 8 is a view illustrating a cross-sectional configuration of a pedal device according to a fifth embodiment, which is a view to assist in the explanation of an elastic member, a holder, a housing, and a passage in the reaction force generator in the pedal device;

FIG. 9 is an enlarged cross-sectional view of the reaction force generator in the pedal device according to the fifth embodiment of FIG. 8, which is a view to assist in the explanation of an elastic member, a holder, a housing, a passage provided in the holder and the like in the reaction force generator;

FIG. 10 is a cross-sectional view illustrating a reaction force generator in a pedal device according to a sixth embodiment, which is a view to assist in the explanation of an elastic member, a holder, a housing, and a passage provided in the holder and the housing in the reaction force generator;

FIG. 11 is a cross-sectional view illustrating a reaction force generator in a pedal device according to a seventh embodiment, which is a view to assist in the explanation of an elastic member, a holder, a housing, and a passage provided in the housing and the holder in the reaction force generator;

FIG. 12 is a cross-sectional view illustrating a reaction force generator in a pedal device according to an eighth embodiment, which is a view to assist in the explanation of an elastic member, a holder, a housing, and a passage provided in the housing in the reaction force generator;

FIG. 13 is a cross-sectional view illustrating a reaction force generator in a pedal device according to a ninth embodiment, which is a view to assist in the explanation of an elastic member, a holder, a housing, and a passage provided in the housing in the reaction force generator;

FIG. 14 is a schematic view illustrating a pedal device according to a tenth embodiment to assist the explanation of a configuration of the pedal device;

FIG. 15 is a cross-sectional view illustrating the reaction force generator in the pedal device according to the tenth embodiment of FIG. 14, which is a view to assist in the explanation of an elastic member, a holder, a housing, and a passage provided in the holder and the housing in the reaction force generator;

FIG. 16 is a cross-sectional view illustrating a reaction force generator in a pedal device according to an eleventh embodiment, which is a view to assist in the explanation of an elastic member, a holder, a housing, and a passage provided in the housing in the reaction force generator;

FIG. 17 is a cross-sectional view illustrating a reaction force generator in a pedal device according to a twelfth embodiment, which is a view to assist in the explanation of an elastic member, a holder, a housing, and a passage provided in the housing in the reaction force generator;

FIG. 18 is a cross-sectional view illustrating a reaction force generator in a pedal device according to a thirteenth embodiment, which is a view to assist in the explanation of an elastic member, a holder, a housing, and a passage provided in the holder and the housing in the reaction force generator;

FIG. 19 is a cross-sectional view illustrating a reaction force generator in a pedal device according to a fourteenth embodiment, which is a view to assist in the explanation of an elastic member, a holder, a housing, and a passage provided in the holder in the reaction force generator;

FIG. 20 is a cross-sectional view illustrating a reaction force generator in a pedal device according to a fifteenth embodiment, which is a view to assist in the explanation of an elastic member, a holder, a housing, and a passage provided in the holder in the reaction force generator;

FIG. 21 is a cross-sectional view illustrating a reaction force generator in a pedal device according to a sixteenth embodiment, which is a view to assist in the explanation of an elastic member, a housing, and a passage provided in the elastic member in the reaction force generator;

FIG. 22 is a cross-sectional view illustrating a single holder of a reaction force generator in a pedal device according to a seventeenth embodiment, which is a view to assist in the explanation of a plurality of passages formed across the cylindrical portion and the bottom of the holder;

FIG. 23 is a cross-sectional view illustrating the reaction force generator in the pedal device according to the seventeenth embodiment of FIG. 22, which is a view to assist in the explanation of the elastic member, the housing, and the passage provided in the elastic member in the reaction force generator;

FIG. 24 is a view of two holders of a reaction force generator in a pedal device according to an eighteenth embodiment as seen from one side in the axial direction, which is a view to assist in the explanation of a plurality of passages provided in the holders;

FIG. 25 is a view of two holders of a reaction force generator in a pedal device according to a nineteenth embodiment as seen from one side in the axial direction, which is a view to assist in the explanation of a plurality of passages provided in the holders;

FIG. 26 is a cross-sectional view to assist in the explanation of an arrangement relationship of two holders and four elastic members in a reaction force generator in a pedal device according to a twentieth embodiment;

FIG. 27 is a cross-sectional view illustrating an elastic member, an accommodation chamber, and a passage according to a twenty-first embodiment, which is a view corresponding to an enlarged view of the elastic member and its periphery in the above fifth embodiment of FIG. 8;

FIG. 28 is a cross-sectional view illustrating an elastic member, an accommodation chamber, and a passage according to a twenty-second embodiment, which is a view corresponding to an enlarged view of the elastic member and its periphery in the above fifth embodiment of FIG. 8; and

FIG. 29 is a cross-sectional view illustrating a housing, an elastic member, and a passage according to a twenty-third embodiment, which is a view corresponding to an enlarged view of the elastic member and its periphery in the above fifth embodiment of FIG. 8.

### DESCRIPTION OF EMBODIMENTS

A pedal device of a comparative example includes a pedal that is depressed by a driver to rotate, and a reaction force generator that generates a reaction force against a rotational force applied by the pedal as the pedal rotates. In the reaction force generator, a holder, a first elastic member, and a second elastic member are accommodated in a housing. The holder is configured to be movable in the vertical direction. The first elastic member is supported by the holder, and is pressed by the rotational force applied by the pedal to be compressed through elastic deformation and to apply an elastic force to the pedal.

The second elastic member is supported by the bottom of the housing, and is pushed by the holder as the holder moves to the vehicle lower side to be compressed through elastic deformation and to apply an elastic force to the holder.

In this case, the reaction force generator applies the elastic forces of the first and second elastic members to the pedal as reaction forces against the rotational force applied by the pedal through the elastic deformation of the first and second elastic members.

The reaction force generator in the pedal device applies the elastic forces of the first and second elastic members to the pedal as reaction forces against the rotational force applied by the pedal.

However, according to the inventors' study in connection with the pedal device of the comparative example, if foreign matter such as water accumulates in the holder, rust, freezing, or the like may occur, thereby causing a malfunction of the holder.

In addition, according to the inventors' study, if foreign matter such as water accumulates in the housing, rust or freezing may occur in the elastic member, thereby causing a malfunction of the elastic member.

Furthermore, according to the inventors' study, foreign matter such as abrasion powder, sand, or dust in the holder and the elastic member may cause malfunctions of the holder and the elastic member.

In view the above, an object of the present disclosure is to provide a pedal device that prevents a malfunction caused by foreign matter.

Hereinafter, embodiments of the present disclosure will be described with reference to the drawings. In the following embodiments, the same or equivalent portions are denoted by the same reference numerals in the drawings to simplify the description.

### First Embodiment

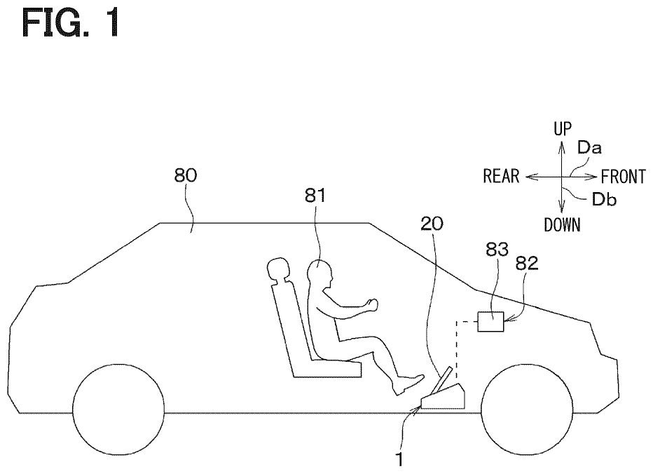

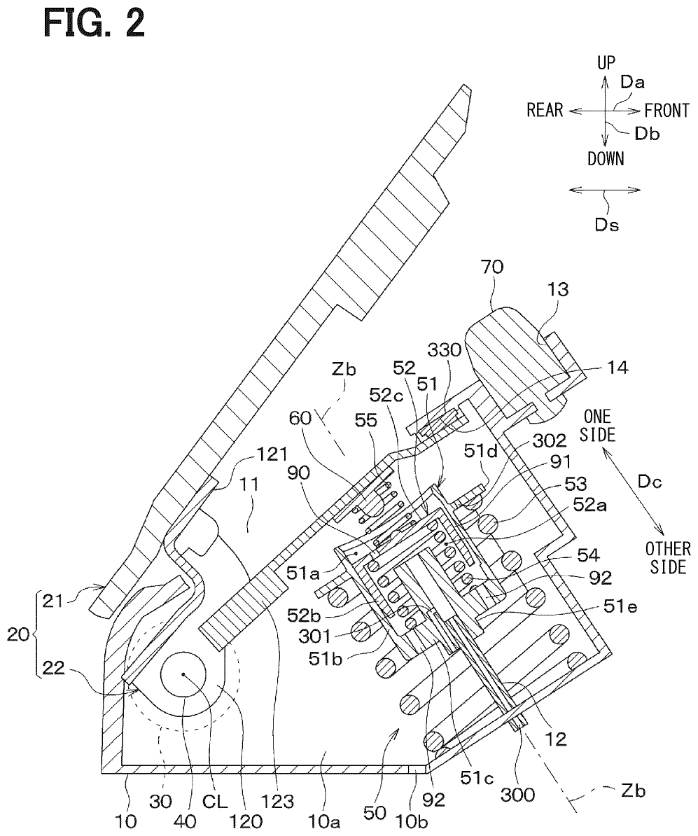

FIG. 1 illustrates an overall configuration of a pedal device 1 for a brake of a vehicle of the present first embodiment. FIG. 2 is a cross-sectional view of the pedal device 1 for the brake of the vehicle of the present first embodiment.

As illustrated in FIG. 1, the pedal device 1 of the present embodiment is installed in a vehicle 80 and receives a brake operation (e.g., depressing and releasing the pedal with the foot) to brake the vehicle by the driver of the vehicle 80.

The vehicle 80 is a vehicle that travels on wheels. Examples of the vehicle 80 include a passenger car, a commercial vehicle, an agricultural construction machine, and a small mobility vehicle.

The pedal device 1 outputs an operation amount signal to a brake control circuit 83 according to the amount of brake operation received. The brake control circuit 83 is a system that drives a brake pad of each wheel by controlling a brake actuator (not illustrated) (e.g., an electric pump that adjusts hydraulic pressure in a hydraulic brake circuit) according to the operation amount signal. As described above, the pedal device 1 is a device for implementing a brake-by-wire system 82.

The four arrows in FIG. 1, up, down, left, and right, respectively, indicate the directions of the vehicle 80 in which the pedal device 1 is installed.

A vehicle travel direction Da and a vehicle vertical direction Db, which is the vertical direction of the vehicle 80 (in other words, the top-bottom direction of the vehicle 80), are indicated by four arrows. In the description of the present embodiment, the front side in the vehicle travel direction Da is also referred to as the front side in the vehicle travel direction, and the rear side in the vehicle travel direction Da is also referred to as the rear side in the vehicle travel direction. The upper side in the vehicle vertical direction Db is also referred to as the vehicle upper side, and the lower side in the vehicle vertical direction Db is also referred to as the vehicle lower side.

As illustrated in FIGS. 1, 2, 3, and 4, the pedal device 1 includes a housing 10, a pedal 20, a rotation angle sensor 30, a rotation shaft 40, a reaction force generator 50, and elastic members 60, 70, 330. The pedal device 1 of the present embodiment is an organ pedal device.

The organ pedal device 1 is configured such that the portion of the pedal 20 stepped on by a driver 81 is positioned on the vehicle upper side (i.e., the upper side in the top-bottom direction when installed in the vehicle) relative to a rotation center CL of the pedal 20.

In the organ pedal device 1, the pedal 20 rotates in a direction such that the portion of the pedal 20 on the vehicle upper side relative to the rotation center CL approaches the vehicle lower side (i.e., the lower side in the top-bottom direction when installed in the vehicle) as the pedal force of the driver 81 applied to the pedal 20 increases.

The rotation center CL of the pedal 20 is the center of rotation in the swing of the pedal 20. In the description of the present embodiment, the rotation center CL of the pedal 20 is also referred to as a pedal axis center (i.e., the axis center of the rotation shaft 40) CL.

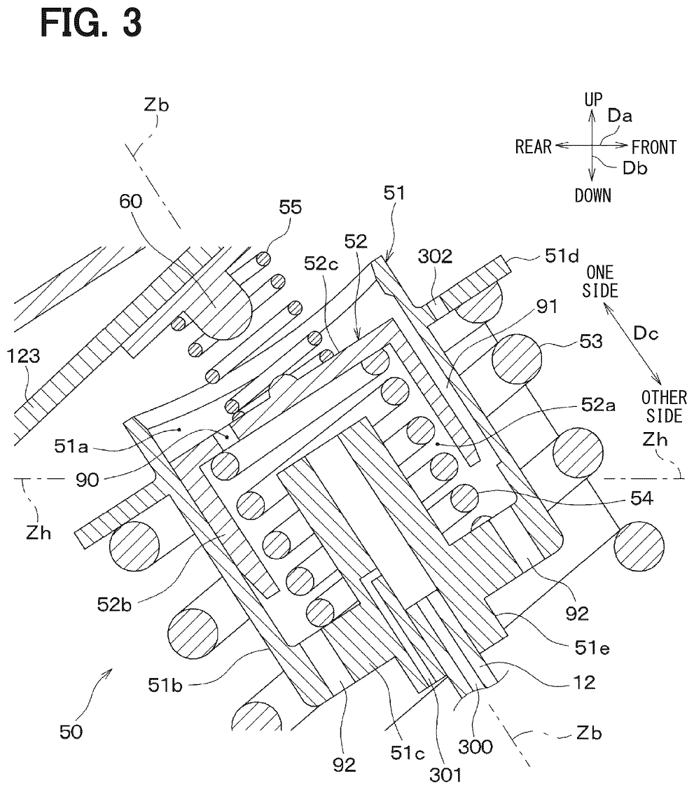

As illustrated in FIGS. 2 and 3, the housing 10 includes an accommodation chamber 10a that accommodates the reaction force generator 50 and the like. The housing 10 includes an opening 11 that opens the accommodation chamber 10a to the vehicle upper side and is fixed to the floor of the vehicle interior. The housing 10 is provided with a support 12 extending axially from its bottom along an axis Zb to be described later. The support 12 is a guide portion that guides a holder 51 of the reaction force generator 50 to be movable in an axial direction Dc.

The support 12 is provided with a passage 300 extending axially along the axis Zb. The lower opening of the passage 300 is open to the outside of the housing 10. The upper opening of the passage 300 communicates with the inside of a shaft support 51e. The inside of the shaft support 51e communicates with a hollow 51a through a hollow 52a.

The passage 300 is disposed on the vehicle lower side of the holder 51 relative to a reference plane Zh. The reference plane Zh is a virtual plane that has the same distance from the lowermost portion of the holder 51 as from the uppermost portion of the holder 51.

As a result, the passage 300 communicates between the outside of the housing 10 and the hollows 52a, 51a. The shaft support 51e is provided with a passage 301 that guides foreign matter such as water from the inside of the shaft support 51e to the vehicle lower side of the shaft support 51e by gravity.

The housing 10 is provided with a passage 10b (i.e., a second passage) that guides foreign matter such as water from the accommodation chamber 10a to the outside of the housing 10 by gravity.

The pedal 20 is depressed by an operator to rotate around the rotation shaft 40. Specifically, the pedal 20 includes a pedal pad 21 and a pedal arm 22.

The pedal pad 21 is disposed on the vehicle upper side of the housing 10. The pedal pad 21 is formed in a long plate shape and receives a depressing operation from the foot of the operator. The pedal arm 22 rotates around the rotation shaft 40 while supporting the pedal pad 21 from the vehicle lower side.

The pedal arm 22 includes a rotation shaft base 120, a pedal pad support 121, and an arm 123. The rotation shaft base 120 is disposed in the housing 10. The rotation shaft base 120 is fixed to the rotation shaft 40 and is configured to be rotatable around the rotation shaft 40. The rotation shaft 40 is rotatably supported by the housing 10.

The pedal pad support 121 is configured to be supported by the rotation shaft base 120 through the opening 11 of the housing 10 to support the pedal pad 21. The arm 123 is disposed in the housing 10 and is formed to extend from the rotation shaft base 120 to the front side in the vehicle travel direction and to the vehicle upper side.

The rotation angle sensor 30 detects the rotation angle of the pedal 20 (i.e., the rotation angle of the rotation shaft 40).

The reaction force generator 50 includes holders 51, 52 and elastic members 53, 54, 55.

The holder 51 is a second holder configured to be movable in the axial direction Dc. The axial direction Dc is a predetermined direction that intersects the vehicle vertical direction Db and intersects the vehicle travel direction Da. Specifically, the axial direction Dc is set to extend toward the rear side in the vehicle travel direction Da as the axial direction Dc approaches the vehicle upper side.

The holder 51 includes a cylindrical portion 51b with the hollow 51a formed in a cylindrical shape around the axis Zb, a bottom 51c that closes the hollow 51a from the other side in the axial direction Dc, and a flange 51d that protrudes radially outward from the cylindrical portion 51b around the axis Zb. The bottom 51c constitutes a support that supports the elastic member 54.

The flange 51d is formed in an annular shape around the axis Zb. The flange 51d is provided with a passage 302 that guides foreign matter such as water on the vehicle upper side of the flange 51d to the vehicle lower side of the flange 51d.

The holder 51 is provided with a shaft support 51e formed in a cylindrical shape through which the support 12 penetrates. The shaft support 51e is supported by the bottom 51c.

The holder 51 of the present embodiment is provided with a passage 91 that communicates the vehicle upper side of the holder 52 with the vehicle lower side of the holder 52 in the hollow 51a.

The passage 91 is formed to be recessed radially outward around the axis Zb from the inner peripheral surface of the cylindrical portion 51b. The passage 91 is covered by the cylindrical portion 52b of the holder 52 from the radially inner side around the axis Zb.

The holder 52 is a first holder disposed in the hollow 51a of the holder 51. The holder 52 is configured to be movable in the axial direction Dc. The holder 52 includes a cylindrical portion 52b with a hollow 52a formed in a cylindrical shape around the axis Zb, and a lid 52c that closes the hollow 52a from one side in the axial direction Dc.

The holder 52 is disposed on the radially inner side around the axis Zb relative to the holder 51. The lid 52c of the holder 52 is provided with a passage 90 (i.e., a first passage) communicating in the vehicle vertical direction Db.

The passage 90 allows foreign matter such as water on the vehicle upper side of the lid 52c to pass to the vehicle lower side of the holder 52 by gravity. The passage 90 allows foreign matter such as sand, dust, and abrasion powder to pass from the hollow 52a to the vehicle upper side of the holder 52 by vibration or the like. The abrasion powder is powder generated by abrasion of the holders 52, 51, the elastic members 53, 54, 55, and the like.

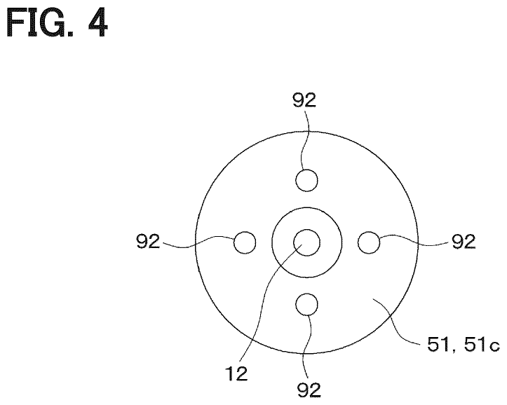

As illustrated in FIGS. 2, 3, and 4, the bottom 51c of the holder 51 is provided with a plurality of passages 92 (i.e., a second passages) communicating in the vehicle vertical direction Db. As illustrated in FIG. 4, the plurality of passages 92 are arranged in the circumferential direction around the axis Zb. The plurality of passages 92 guide foreign matter such as water on the vehicle upper side of the bottom 51c of the holder 51 to the vehicle lower side of the bottom 51c of the holder 51.

In the present embodiment, as the plurality of passages 92, four passages 92 are provided at the bottom 51c of the holder 51. The plurality of passages 92 are arranged on the vehicle lower side of the holder 51 relative to the reference plane Zh. The reference plane Zh is a virtual plane that has the same distance from the lowermost portion of the holder 51 as from the uppermost portion of the holder 51.

Each of the holders 51, 52 of the present embodiment is made of a metal material or a resin material.

The elastic member 53 is, for example, a coil spring formed in a spiral shape around the axis Zb. The elastic member 53 is disposed between the bottom of the housing 10 and the flange 51d of the holder 51.

As a result, the elastic member 53 is supported by the bottom of the housing 10 to support the holder 51. The elastic member 53 of the present embodiment constitutes a second or third elastic member.

The elastic member 54 is, for example, a coil spring formed in a spiral shape around the axis Zb. The elastic member 54 is disposed in the hollow 52a of the holder 52. The elastic member 54 is disposed between the bottom 51c of the holder 51 and the lid 52c of the holder 52.

As a result, the elastic member 54 is supported by the bottom 51c of the holder 51 to support the lid 52c of the holder 52. The elastic member 54 of the present embodiment constitutes a first or second elastic member.

The elastic member 55 is, for example, a second elastic member as a coil spring formed in a spiral shape around the axis Zb. The elastic member 55 is disposed between the arm 123 of the pedal arm 22 and the lid 52c of the holder 52.

As a result, the elastic member 55 is supported by the holder 52 to support the pedal 20.

The elastic members 53, 54, 55 configured in this manner applies elastic forces as reaction forces against the rotational force to the arm 123 of the pedal arm 22.

Each of the elastic members 53, 54, 55 of the present embodiment is made of, for example, a metal material.

The elastic member 60 is made of an elastic member such as rubber and is supported by the arm 123 of the pedal arm 22. The elastic member 60 is formed to be projected toward the lid 52c of the holder 52.

The elastic member 60 is disposed on the vehicle lower side of the arm 123 of the pedal arm 22, and hits the lid 52c of the holder 52 to be compressed through elastic deformation and apply an elastic force to the lid 52c of the holder 52.

The elastic member 70 is disposed on the radially outer side of a reaction force generator 50 around the rotation center CL of the pedal 20. The elastic member 70 is press-fitted into an accommodation chamber 13 of the housing 10. That is, the elastic member 70 is held in the housing 10 while being accommodated in the accommodation chamber 13 of the housing 10. The elastic member 70 of the present embodiment hits the pedal pad 21 to be compressed through elastic deformation and apply an elastic force to the pedal pad 21.

The elastic member 330 is press-fitted into an accommodation chamber 14 of the housing 10. That is, the elastic member 330 is supported by the housing 10 while being accommodated in the accommodation chamber 14 of the housing 10. The elastic member 330 hits the arm 123 to be compressed through elastic deformation and apply an elastic force to the arm 123.

The elastic members 60, 70, 330 of the present embodiment are made of elastic members such as rubber.

Next, the operation of the pedal device 1 of the present embodiment will be described.

First, when the driver 81 performs a brake operation on the pedal pad 21 of the pedal 20 and the pedal force of the driver 81 is applied to the pedal pad 21 of the pedal 20, the pedal 20 rotates around the rotation center CL.

Specifically, the pedal arm 22, the pedal pad 21, and the rotation shaft 40 swing around the rotation center CL so as to move to the front side in the vehicle travel direction. In other words, the pedal 20 swings, changing its position from the non-depressed state to the fully depressed state.

At this time, the rotation angle sensor 30 outputs an electric signal indicating the rotation angle of the rotation shaft 40 to the brake control circuit 83. The brake control circuit 83 drives and controls a brake circuit included in the brake-by-wire system 82 to generate the hydraulic pressure (e.g., oil pressure) needed to brake the vehicle 80, and this hydraulic pressure drives the brake pads to slow or stop the vehicle 80.

At this time, the arm 123 of the pedal arm 22 and the elastic member 60 rotate around the rotation center CL as the pedal 20 rotates. Thus, the rotational force of the pedal 20 is applied by the arm 123 to the elastic member 55 from one side in the axial direction Dc. Hence, the elastic member 55 is compressed through elastic deformation while being supported by the lid 52c of the holder 52.

At this time, the elastic force of the elastic member 55 is applied to the arm 123 as a reaction force against the rotational force of the pedal 20.

In addition, the elastic force of the elastic member 55 is applied to the lid 52c of the holder 52 from one side in the axial direction Dc. This leads to the displacement of the holder 52 to the other side in the axial direction Dc. Hence, the lid 52c of the holder 52 presses the elastic member 54 from one side in the axial direction Dc.

Therefore, the elastic member 54 is compressed through elastic deformation while being supported by the bottom 51c of the holder 51. The elastic force of the elastic member 54 is thus applied to the bottom 51c of the holder 51 and the lid 52c of the holder 52.

This leads to the displacement of the holder 51 to the other side in the axial direction Dc due to the elastic force of the elastic member 54. Accordingly, the elastic member 53 is pressed from one side in the axial direction Dc by the flange 51d of the holder 51 while being supported by the bottom surface of the housing 10.

As a result, the elastic member 53 is compressed through elastic deformation and applies an elastic force to the holder 51. Through such elastic deformation of each of the elastic members 53, 54, 55, the reaction force against the rotational force of the pedal 20 is applied to the pedal 20.

When the pedal 20 swings, changing its position from the non-depressed state to the fully depressed state, the elastic members 53, 54, 55 are increasingly elastically deformed as the pedal 20 approaches the fully depressed state from the non-depressed state. For this reason, as the pedal 20 approaches the fully depressed state from the non-depressed state, the reaction force applied by the elastic member 70 to the pedal 20 increases.

Thereafter, when the pedal 20 is released from the foot of the driver 81 and the application of the pedal force of the driver 81 to the pedal 20 is stopped, the elastic deformation of the elastic members 53, 54, 55 returns.

In this case, with the elastic forces of the elastic members 53, 54, 55 applied to the pedal 20, the pedal arm 22, the pedal pad 21, and the rotation shaft 40 swing around the rotation center CL so as to move to the rear side in the vehicle travel direction. In other words, the pedal 20 swings, changing its position from the fully depressed state to the non-depressed state.

At this time, foreign matter such as water on the vehicle upper side of the lid 52c of the holder 52 is guided by gravity to the vehicle lower side of the holder 52 through the passages 90, 91.

The foreign matter guided to the vehicle lower side of the holder 52 in this manner is guided to the vehicle lower side of the holder 51 through the plurality of passages 92. The foreign matter on the vehicle upper side of the flange 51d is guided to the vehicle lower side of the flange 51d through the passage 302. In addition, the foreign matter inside the shaft support 51e is guided by gravity to the vehicle lower side of the holder 51 through the passage 301.

The foreign matter guided to the vehicle lower side of the holder 51 in this manner is guided by gravity to the bottom surface of the housing 10. The guided foreign matter is guided to the outside of the accommodation chamber 10a (i.e., the housing 10) through the passage 10b of the housing 10.

The pedal force applied to the pedal 20 by the driver 81 causes vibration in the holder 52. As the vehicle travels, vibration occurs in the holder 52. Such vibration causes foreign matter such as sand, abrasion powder, and dust in the hollow 52a of the holder 52 to move to the outside of the holder 52 through the passage 92 and the vehicle upper side of the holder 51.

The moved foreign matter is guided by gravity to the outside of the housing 10 through the passage 10b of the housing 10.

Furthermore, the foreign matter inside the shaft support 51e is guided by gravity to the outside of the housing 10 through the passage 300.

According to the present embodiment described above, the pedal device 1 includes the pedal 20 that is depressed by the operator to rotate around the rotation shaft 40.

The pedal device 1 includes the elastic member 55 that receives the rotational force of the pedal 20 from one side in the axial direction Dc as the pedal 20 rotates, to be compressed through elastic deformation and apply an elastic force to the pedal 20 as a reaction force against the rotational force.

The pedal device 1 includes the holder 52 that is configured to be displaceable in the axial direction Dc and supports the elastic member 55 from the other side in the axial direction Dc.

The pedal device 1 includes the elastic member 55 that supports the holder 52 from the other side in the axial direction Dc, and receives the elastic force of the elastic member 54 from one side in the axial direction Dc via the holder 52 to be compressed through elastic deformation and apply an elastic force to the holder 52.

The lid 52c of the holder 52 includes the passage 90 that communicates the hollow 52a of the holder 52 with the vehicle upper side of the holder 52 and allows foreign matter to pass to the outside of the holder 52 by gravity or vibration.

Therefore, the foreign matter can be discharged from the hollow 52a of the holder 52 to the outside of the holder 52 through the passage 90. This can prevent foreign matter from accumulating in the hollow 52a of the holder 52.

Therefore, it is possible to prevent rust, freezing, and malfunctions such as the generation of abnormal noise in the holder 52 caused by foreign matter such as water. It is possible to prevent foreign matter such as abrasion powder, sand, and dust in the holder 52 and the elastic member 54 from causing malfunctions of the holder 52 and the elastic member 54. When the holder 52 is made of a resin material, it is possible to prevent hydrolysis in the holder 52. Thus, a malfunction does not occur in the holder 52 caused by hydrolysis of the holder 52.

Furthermore, foreign matter such as abrasion powder, sand, or dust is not clogged between the holders 51, 52, and malfunctions of the holders 51, 52 do not occur. The expansion and contraction of the elastic members 53, 54, 55 are not hindered by clogging of foreign matter such as abrasion powder, sand, or dust in the elastic members 53, 54, 55.

As described above, it is possible to prevent malfunctions of the holder 52 and the elastic member 54 caused by foreign matter.

In the present embodiment configured as described above, the following effects (a), (b), (c), (d), and (e) can be obtained. (a) The pedal device 1 includes the holder 51 that is configured to be displaceable in the axial direction Dc and supports the elastic member 54 from the other side in the axial direction Dc. The pedal device 1 includes the elastic member 53 that supports the holder 51 from the other side in the axial direction Dc and receives the elastic force of the elastic member 54 via the holder 51 to be compressed through elastic deformation.

The bottom 51c of the holder 51 includes the passage 92 that guides foreign matter from the hollow 51a of the holder 51 to the vehicle lower side of the holder 51 by gravity.

Therefore, the foreign matter can be guided by gravity from the hollow 52a of the holder 51 to the vehicle lower side of the holder 51. This can prevent a malfunction of the elastic member 53 caused by the foreign matter in the hollow 52a of the holder 51. When the holder 51 is made of a resin material, it is possible to prevent hydrolysis in the holder 51. Thus, a malfunction does not occur in the holder 51 caused by hydrolysis of the holder 51. (b) The pedal device 1 includes the housing 10 forming the accommodation chamber 10a that accommodates the elastic members 55, 54, 53 and the holders 51, 52, and the passage 10b that guides foreign matter from the accommodation chamber 10a to the outside of the housing 10. Hence, the foreign matter can be guided by gravity from the inside of the accommodation chamber 10a to the outside of the accommodation chamber 10a.

Therefore, it is possible to prevent malfunctions of the elastic members 55, 54, 53 and the holders 51, 52 caused by foreign matter. (c) The pedal device 1 includes the support 12 that guides the holder 51 such that the holder 51 is displaceable in the axial direction Dc and includes the passage 300 that guides foreign matter from the inside of the hollow 51a of the holder 51 to the outside of the hollow 51a.

Thus, it is possible for the passage 300 of the support 12 to guide the foreign matter from the inside of the hollow 51a of the holder 51 to the outside of the holder 51 by gravity. Therefore, the foreign matter can be discharged from the hollow 51a of the holder 51 more satisfactorily. (d) In the pedal device 1, the passage 91 that communicates the vehicle upper side of the holder 51 with the vehicle lower side of the holder 52 is provided on the inner peripheral surface of the holder 52. Hence, the foreign matter can pass from the vehicle upper side of the holder 52 to the vehicle lower side of the holder 52 through the passage 91 by gravity. Therefore, it is possible to prevent a malfunction of the elastic member 55 disposed on the vehicle upper side of the holder 52 caused by foreign matter. (e) With the pedal device 1 installed in the vehicle, the axial direction Dc of each of the elastic members 53, 54, 55 is oblique to a horizontal direction Ds. Thus, each of the elastic members 53, 54, 55 expands and contracts as a spring through elastic deformation in the axial direction Dc oblique to the horizontal direction Ds. Therefore, compared to a case where the axial direction Dc of each of the elastic members 53, 54, 55 is parallel to the horizontal direction Ds, foreign matter is easily discharged from the elastic members 53, 54, 55. Therefore, the discharge ability to discharge foreign matter can be improved.

### First Modification of First Embodiment

In the above first embodiment, an example in which the passage 91 is provided in the holder 52 to communicate the vehicle upper side of the holder 52 with the vehicle lower side of the holder 51 has been described.

However, instead of this, a passage may be provided on the outer peripheral surface of the holder 52, and the vehicle upper side of the holder 52 and the vehicle lower side of the holder 52 may communicate with each other by this passage.

Specifically, the passage is constituted by a recess recessed radially inward around the axis Zb from the outer peripheral surface of the holder 52. This recess is covered with the inner peripheral surface of the holder 51.

As a result, foreign matter such as water can be guided from the vehicle upper side of the holder 52 to the vehicle lower side of the holder 52 using the passage of the holder 52.

### Second Modification of First Embodiment

In the above first embodiment, an example has been described in which the support 12 that guides the holder 51 such that the holder 51 is displaceable in the axial direction Dc is provided.

However, instead of this, a guide portion that guides the holder 52 such that the holder 52 is displaceable in the axial direction Dc may be provided. In this case, a passage that discharges foreign matter from the inside of the hollow 52a of the holder 52 may be provided in the guide portion.

### Second Embodiment

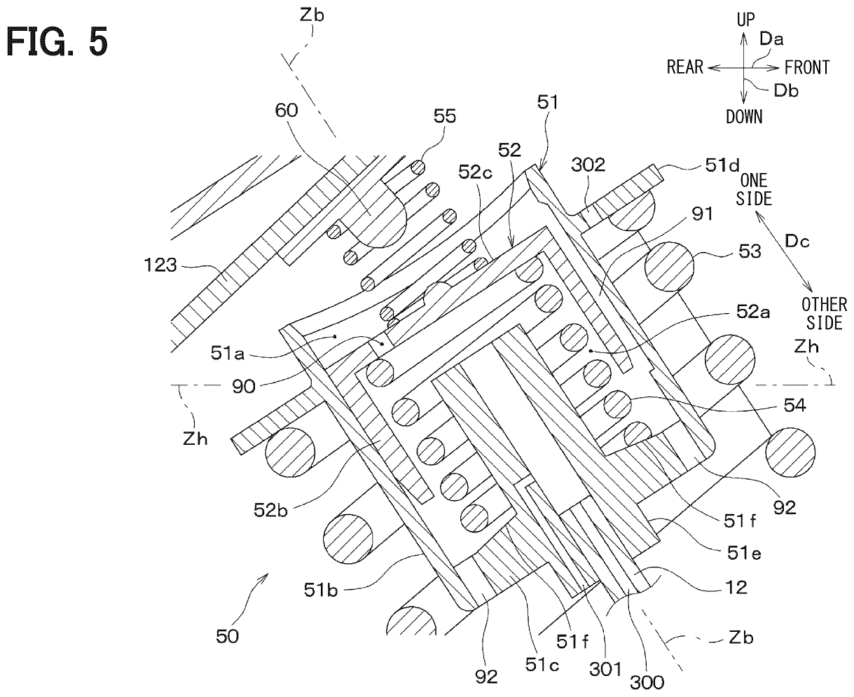

For the holder 51 in the pedal device 1 of the present second embodiment, an example in which a bottom surface 51f of the bottom 51c is formed in an inclined shape in order to improve the discharge ability to discharge foreign matter in the pedal device 1 of the above first embodiment will be described with reference to FIG. 5.

FIG. 5 is a partially enlarged view illustrating the reaction force generator 50 and its peripheral portion in the pedal device 1 of the present embodiment.

As illustrated in FIG. 5, the plurality of passages 92 of the pedal device 1 of the present embodiment are provided on the radially outer side around the axis Zb at the bottom 51c of the holder 51. The plurality of passages 92 are arranged in the circumferential direction around the axis Zb at the bottom 51c of the holder 51.

The bottom surface 51f as an inclined surface is formed on one side of the bottom 51c of the holder 51 in the axial direction Dc. The bottom surface 51f of the bottom 51c of the holder 51 is formed in an inclined shape toward the other side in the axial direction Dc as the bottom surface 51f approaches the radially outer side from the radially inner side around the axis Zb. That is, the bottom surface 51f of the bottom 51c of the holder 51 is formed in an inclined shape toward the other side in the axial direction Dc as the bottom surface 51f approaches the plurality of passages 92 from the radially inner side around the axis Zb.

According to the present embodiment described above, foreign matter on the vehicle upper side of the bottom surface 51f can be satisfactorily collected in the plurality of passages 92. Therefore, the discharge ability to discharge foreign matter at the bottom 51c of the holder 51 can be improved.

### Third Embodiment

In the above second embodiment, an example in which the plurality of passages 92 are provided on the radially outer side of the bottom 51c of the holder 51 around the axis Zb has been described.

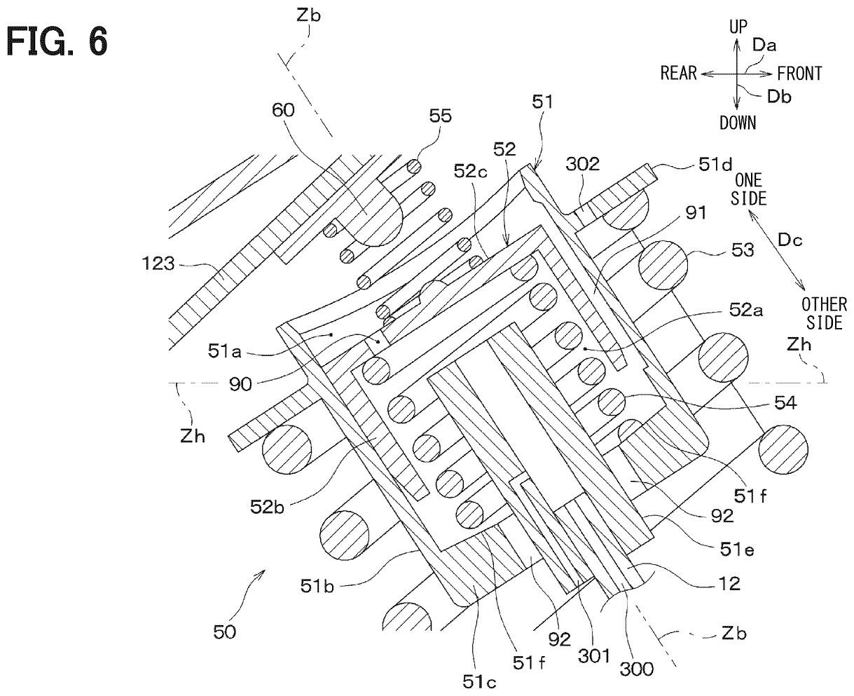

However, instead of this, the present third embodiment in which the plurality of passages 92 are provided on the radially inner side of the bottom 51c of the holder 51 around the axis Zb will be described with reference to FIG. 6.

FIG. 6 is a partially enlarged view illustrating the reaction force generator 50 and its peripheral portion in the pedal device 1 of the present embodiment.

The plurality of passages 92 are provided on the radially inner side of the bottom 51c of the holder 51 around the axis Zb. The plurality of passages 92 are arranged in the circumferential direction around the axis Zb from the radially inner side around the axis Zb relative to the shaft support 51e.

The bottom surface 51f of the bottom 51c of the holder 51 is formed as an inclined surface to be inclined toward the other side in the axial direction Dc as the bottom surface 51f approaches the radially outer side from the radially inner side around the axis Zb. That is, the bottom surface 51f of the bottom 51c of the holder 51 is formed in an inclined shape toward the other side in the axial direction Dc as the bottom surface 51f approaches the plurality of passages 92 from the radially outer side around the axis Zb.

According to the present embodiment described above, foreign matter on the vehicle upper side of the bottom surface 51f can be satisfactorily collected in the plurality of passages 92. Therefore, the discharge ability to discharge foreign matter at the bottom 51c of the holder 51 can be improved.

### Fourth Embodiment

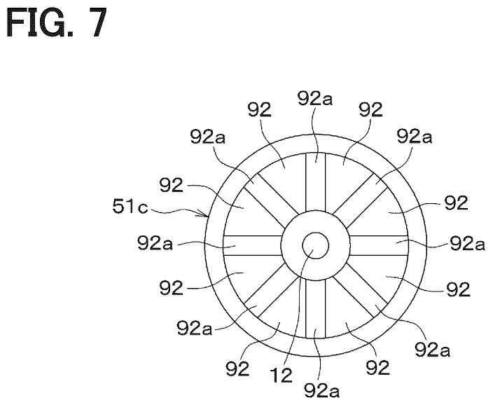

An example in which the bottom 51c of the holder 51 of the present fourth embodiment is formed such that the plurality of ribs 92a are radially formed around the axis Zc in the holder 51 of the above first embodiment will be described with reference to FIG. 7.

FIG. 7 is a view of the bottom 51c of the holder 51 in the pedal device 1 of the present embodiment as seen from the other side in the axial direction Dc.

The plurality of passages 92 are arranged in the circumferential direction around the axis Zb at the bottom 51c of the holder 51. The plurality of ribs 92a are disposed between two adjacent passages 92 among the plurality of passages 92 at the bottom 51c of the holder 51.

The plurality of ribs 92a are arranged in the circumferential direction around the axis Zc. The plurality of ribs 92a are formed radially around the axis Zc. As a result, the plurality of passages 92 are formed at the bottom 51c of the holder 51.

According to the present embodiment described above, the plurality of ribs 92a are each disposed between two adjacent passages 92 among the plurality of passages 92 at the bottom 51c and are formed radially around the axis Zc, thereby forming the plurality of passages 92, respectively.

Therefore, the bottom 51c can ensure the discharge ability to discharge foreign matter through the plurality of passages 92 while satisfactorily supporting the elastic member 54.

### Fifth Embodiment

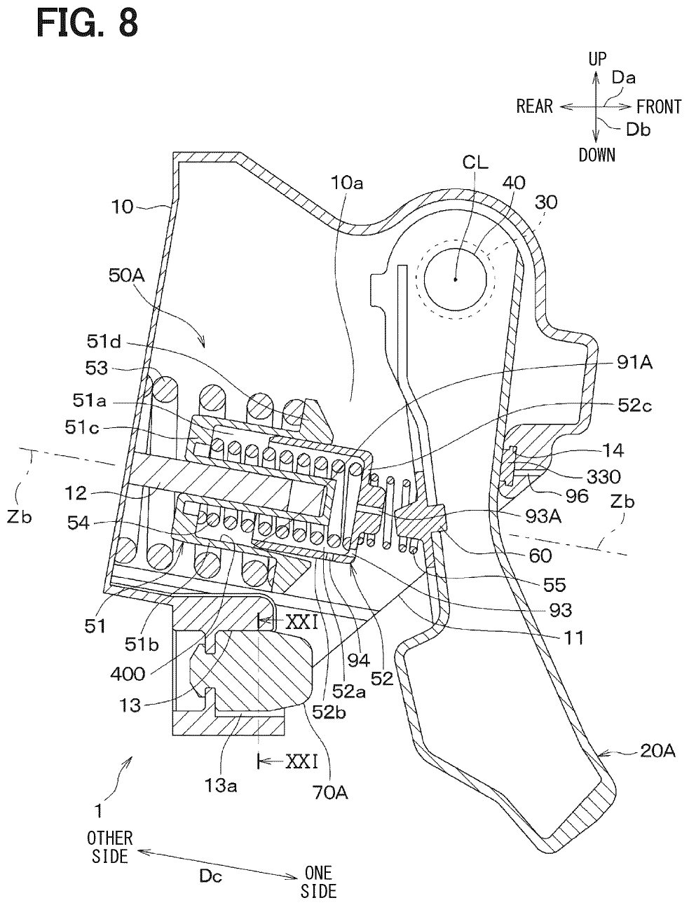

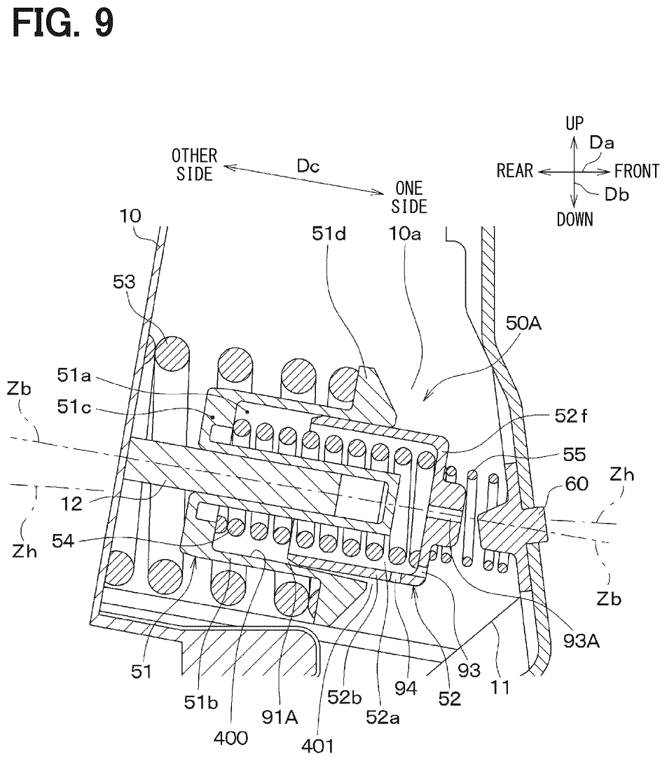

In the above first embodiment, an example in which the organ pedal device is used as the pedal device 1 has been described. However, instead of this, the present fifth embodiment in which a pendant pedal device is used as the pedal device 1 will be described with reference to FIGS. 8 and 9.

FIG. 8 is a cross-sectional view of the pedal device 1 for the brake of the vehicle of the present embodiment. FIG. 9 is a partially enlarged view illustrating the reaction force generator 50 and its peripheral portion in the pedal device 1 of the present embodiment.

In the present embodiment, as illustrated in FIGS. 8 and 9, the pedal device 1 includes a pedal 20A in place of the pedal 20 and a reaction force generator 50A in place of the reaction force generator 50 in the pedal device 1 of the above first embodiment. The pedal device 1 includes an elastic member 70A instead of the elastic member 70 in the pedal device 1 of the above first embodiment.

In the pedal device 1 of the present embodiment and the pedal device 1 of the above first embodiment, the same reference numerals denote the same components, and the description thereof will be omitted.

The pedal device 1 of the present embodiment is a pendant pedal device. The pendant pedal device 1 is configured such that the portion of the pedal 20A stepped on by the driver 81 is positioned on the vehicle lower side (i.e., the lower side in the top-bottom direction when installed in the vehicle) relative to the rotation center CL of the pedal 20A. In the pendant pedal device 1, the pedal 20A swings in a direction such that the portion of the pedal 20A on the vehicle lower side relative to the rotation center CL approaches the front side in the vehicle travel direction as the pedal force of the driver 81 applied to the pedal 20A increases.

The reaction force generator 50A of the present embodiment and the reaction force generator 50 of the above first embodiment are substantially similarly provided with holders 51, 52 and elastic members 53, 54, 55, with the only difference being the arrangement relationship of the holders 51, 52. The holder 51 is disposed on the radially outer side around the axis Zb relative to the holder 52.

The cylindrical portion 51b of the holder 51 is provided with a passage 91A that allows foreign matter to pass from the hollow 51a to the vehicle lower side of the holder 51. The passage 91A is formed to be recessed radially outward around the axis Zb on an inner peripheral surface 400 of the cylindrical portion 51b of the holder 51 around the axis Zb. That is, the passage 91A is formed by the inner peripheral surface 400 around the axis Zb of the cylindrical portion 51b of the holder 51.

The passage 91A is covered by the outer peripheral surface of the cylindrical portion 52b of the holder 52 from the radially inner side around the axis Zb. The passage 91A is disposed on the vehicle lower side of the holder 51 relative to the reference plane Zh.

The reference plane Zh is a virtual plane that has the same distance from the lowermost portion of the holder 52 as from the uppermost portion of the holder 52.

In the present embodiment, the passage 91A includes an outlet 401 that opens to one side of the cylindrical portion 52b of the holder 52 in the axial direction Dc. An inner peripheral surface 400 of the cylindrical portion 51b of the holder 51 around the axis Zc is formed in an inclined shape radially outward around the axis Zb from the other side in the axial direction Dc toward one side in the axial direction Dc.

That is, the inner peripheral surface 400 is formed in an inclined shape radially outward around the axis Zb as the inner peripheral surface 400 approaches the outlet 401 from the other side in the axial direction Dc. One side of the cylindrical portion 51b of the holder 51 in the axial direction Dc is positioned on the vehicle lower side relative to the other side in the axial direction Dc.

Here, the inner peripheral surface 400 serves to guide foreign matter in the hollow 51a of the holder 51 to the outlet 401. As described above, the passage 91A is formed in an inclined shape radially outward around the axis Zb as the passage 91A approaches the outlet 401 from the other side in the axial direction Dc.

In the present embodiment, the passage 91A may be formed over the entire circumference around the axis Zb on the inner peripheral surface 400. Alternatively, the passage 91A may be formed in a part of the inner peripheral surface 400 in the circumferential direction around the axis Zb.

The inner peripheral surface 400 may be formed with a draft angle used to mold the hollow 51a when the holder 51 is injection-molded using a metal material or a resin material.

In the reaction force generator 50A of the present embodiment, the elastic member 55 is disposed between the pedal 20A and the lid 52c of the holder 52. The elastic member 54 is disposed between the bottom 51c of the holder 51 and the lid 52c of the holder 52. The elastic member 53 is disposed between the flange 51d of the holder 51 and the bottom surface of a housing 10.

The elastic member 70A of the present embodiment is disposed on the radially outer side of the reaction force generator 50A around the rotation center CL of the pedal 20A. The elastic member 70A is made of an elastic member such as rubber, and is press-fitted into the accommodation chamber 13 of the housing 10.

That is, the elastic member 70A is held in the housing 10 while being accommodated in the accommodation chamber 13 of the housing 10. The elastic member 70A is provided with a passage 13a that guides foreign matter in the accommodation chamber 13 to the outside of the accommodation chamber 13 by gravity. The passage 13a is formed to be recessed inward from the outer surface of the elastic member 70A.

The elastic member 330 of the present embodiment is disposed on the opposite side to the elastic member 70A and the reaction force generator 50 in the rotation direction around the rotation center CL. The elastic member 330 is made of an elastic member such as rubber.

The elastic member 330 is press-fitted into the accommodation chamber 14 of the housing 10. That is, the elastic member 330 is supported by the housing 10 while being accommodated in the accommodation chamber 14 of the housing 10.

The elastic member 330 is compressed through elastic deformation when a rotational force is applied by the pedal 20A as the pedal 20A rotates and apply an elastic force to the pedal 20A as a reaction force against the rotational force. The housing 10 is provided with a passage 96 that guides foreign matter in the accommodation chamber 14 to the outside of the accommodation chamber 14 by gravity.

Next, the operation of the pedal device 1 of the present embodiment will be described.

First, when the pedal force of the driver 81 is applied to the pedal pad 21 of the pedal 20A, the pedal 20A rotates around the rotation center CL. Specifically, the pedal 20A swings around the rotation center CL so as to move to the front side in the vehicle travel direction. In other words, the pedal 20A swings, changing its position from the non-depressed state to the fully depressed state.

At this time, the rotation angle sensor 30 outputs an electric signal indicating the rotation angle of the rotation shaft 40 to the brake control circuit 83.

As a result, the rotational force of the pedal 20A is applied to the elastic member 55 from one side in the axial direction Dc. Hence, the elastic member 55 is compressed through elastic deformation while being supported by the lid 52c of the holder 52. At this time, the elastic force of the elastic member 55 is applied to the pedal 20A as a reaction force against the rotational force of the pedal 20A.

In addition, the elastic force of the elastic member 55 is applied to the lid 52c of the holder 52 from one side in the axial direction Dc. This leads to the displacement of the holder 52 to the other side in the axial direction Dc. Accordingly, the lid 52c of the holder 52 presses the elastic member 54 from one side in the axial direction Dc.

Therefore, the elastic member 54 is compressed through elastic deformation while being supported by the bottom 51c of the holder 51. The elastic force of the elastic member 54 is thus applied to the bottom 51c of the holder 51 and the lid 52c of the holder 52.

This leads to the displacement of the holder 51 to the other side in the axial direction Dc due to the elastic force of the elastic member 54. Accordingly, the elastic member 53 is pressed from one side in the axial direction Dc by the flange 51d of the holder 51 while being supported by the bottom surface of the housing 10, so that the elastic member is compressed through elastic deformation and applies an elastic force to the holder 51.

Through such elastic deformation of each of the elastic members 53, 54, 55, the reaction force against the rotational force of the pedal 20A is applied to the pedal 20A.

Furthermore, the elastic member 70A is pressed by the rotational force of the pedal 20A applied by the pedal 20A, to be compressed through elastic deformation. Accordingly, the elastic member 70A applies an elastic force to the pedal 20A as a reaction force against the rotational force of the pedal 20A.

When the pedal 20A swings, changing its position from the non-depressed state to the fully depressed state, the elastic members 53, 54, 55, 70A are increasingly elastically deformed as the pedal 20A approaches the fully depressed state from the non-depressed state. For this reason, as the pedal 20A approaches the fully depressed state from the non-depressed state, the reaction forces applied by the elastic members 53, 54, 55, 70A to the pedal 20A increase.

Thereafter, when the pedal 20A is released from the foot of the driver 81 and the application of the pedal force of the driver 81 to the pedal 20A is stopped, the elastic deformation of the elastic members 53, 54, 55, 70A returns.

In this case, with the elastic forces of the elastic members 53, 54, 55, 70A applied to the pedal 20A, the pedal 20A swings around the rotation center CL so as to move to the rear side in the vehicle travel direction. In other words, the pedal 20A swings, changing its position from the fully depressed state to the non-depressed state.

At this time, the elastic member 330 is pressed by the rotational force of the pedal 20A applied by the pedal 20A and is compressed through elastic deformation. Therefore, the elastic force of the elastic member 330 is applied to the pedal 20A as a reaction force against the rotational force of the pedal 20A.

At this time, foreign matter such as water present in the hollow 52a of the holder 52 is guided by gravity to the vehicle lower side of the holder 52 through passages 93, 94. Foreign matter such as water present in the hollow 51a of the holder 51 is guided by gravity to the vehicle lower side of the holder 51 through the passage 91A.

In this manner, the foreign matter guided to the vehicle lower side of each of the holders 52, 51 is guided by gravity to the bottom surface of the housing 10. The guided foreign matter is guided to the outside of the accommodation chamber 10a (i.e., the housing 10) through the opening 11 of the housing 10.

Foreign matter such as water, dust, sand, and abrasion powder in the accommodation chamber 14 of the housing 10 is guided to the outside of the accommodation chamber 14 through the passage 96 by the vibration or gravity described above.

Furthermore, foreign matter such as water, dust, sand, and abrasion powder in the accommodation chamber 13 of the housing 10 is guided to the outside of the accommodation chamber 14 through the passage 13a by the vibration or gravity described above.

Furthermore, foreign matter in the accommodation chamber 13 of the housing 10 passes through the passage 13a to the outside of the accommodation chamber 13 by the vibration or gravity described above.

The foreign matter in the accommodation chamber 14 of the housing 10 passes through the passage 96 to the outside of the accommodation chamber 14 by the vibration or gravity described above.

According to the present embodiment described above, the pedal device 1 includes the pedal 20A that is depressed by the operator to rotate around the rotation shaft 40.

The pedal device 1 includes the elastic member 55 that receives the rotational force of the pedal 20A from one side in the axial direction Dc as the pedal 20A rotates, to be compressed through elastic deformation and apply an elastic force to the pedal 20A as a reaction force against the rotational force.

The pedal device 1 includes the holder 52 that is configured to be displaceable in the axial direction Dc and supports the elastic member 55 from the other side in the axial direction Dc.

The pedal device 1 includes the elastic member 55 that supports the holder 52 from the other side in the axial direction Dc, and receives the elastic force of the elastic member 54 from one side in the axial direction Dc via the holder 52 to be compressed through elastic deformation and apply an elastic force to the holder 52.

The holder 52 includes at least passages 93, 94 that guide foreign matter from the vehicle upper side to the vehicle lower side of the holder 52 by the vibration or gravity described above.

Therefore, foreign matter such as water can be guided from the hollow 52a of the holder 52 to the vehicle lower side of the holder 52 through the passages 93, 94. This can prevent a malfunction of the elastic member 54 caused by the foreign matter in the hollow 52a of the holder 52.

In the present embodiment configured as described above, the following effects (f), (g), (h), (i), and (j) can be obtained. (f) The housing 10 includes the opening 11 that guides foreign matter in the accommodation chamber 10a to the outside of the accommodation chamber 10a by the vibration or gravity described above. Thus, the foreign matter in the accommodation chamber 10a can be satisfactorily discharged to the outside of the accommodation chamber 10a. (g) The holder 52 includes the cylindrical portion 52b formed in a cylindrical shape around the axis Zb extending in the axial direction Dc, and a bottom 52f as a cover member closing the cylindrical portion 52b from one side in the axial direction Dc. (h) The housing 10 is provided with the passage 96 that guides foreign matter from the accommodation chamber 14 to the outside of the accommodation chamber 14. Therefore, foreign matter such as water can be discharged from the accommodation chamber 14. Therefore, it is possible to prevent hydrolysis in the elastic member 330 in the accommodation chamber 14.

Here, a virtual plane that has the same distance from the lowermost portion of the holder 52 as from the uppermost portion of the holder 52 (i.e., equidistant) is defined as the reference plane Zh. The distance is the shortest distance from the lowermost portion or the uppermost portion.

The passages 93, 94 are disposed on the vehicle lower side of the holder 52 relative to the reference plane Zh. In the present embodiment, the reference plane Zh of the holder 52 and the reference plane Zh of the holder 52 are a common virtual plane.

Here, the passage 93 is disposed at the bottom 52f of the holder 52. The passage 94 is disposed in the cylindrical portion 52b. Thus, the foreign matter can be satisfactorily discharged by gravity from the hollow 52a of the holder 52 to the vehicle lower side of the holder 52 through the passages 93, 94. (i) The passage 93A is disposed at a position within the bottom 52f of the holder 52 that includes the reference plane Zh. Hence, the foreign matter can be satisfactorily discharged by gravity from the hollow 52a of the holder 52 to the vehicle lower side of the holder 52 through the passage 93A. (j) The inner peripheral surface 400 forming the passage 91A of the cylindrical portion 51b of the holder 51 is formed in an inclined shape radially outward around the axis Zb as the inner peripheral surface 400 approaches the outlet 401 from the other side in the axial direction Dc. Thus, the inner peripheral surface 400 can satisfactorily guide the foreign matter in the hollow 51a of the holder 51 to the outlet 401. Therefore, it is possible to improve the discharge ability to discharge foreign matter in the hollow 51a of the holder 51 to the outside of the holder 51.

### Modification of Fifth Embodiment

In the above fifth embodiment, an example in which the recess recessed radially outward around the axis Zb on the inner peripheral surface of the cylindrical portion 51b of the holder 51 is the passage 91A has been described.

However, instead of this, on the outer peripheral surface of the cylindrical portion 52b of the holder 52, a recessed portion recessed radially inward around the axis Zb may be used as the passage 91A.

### Sixth Embodiment

In the above first embodiment, an example of the reaction force generator 50 using the three elastic members 55, 54, 53 has been described.

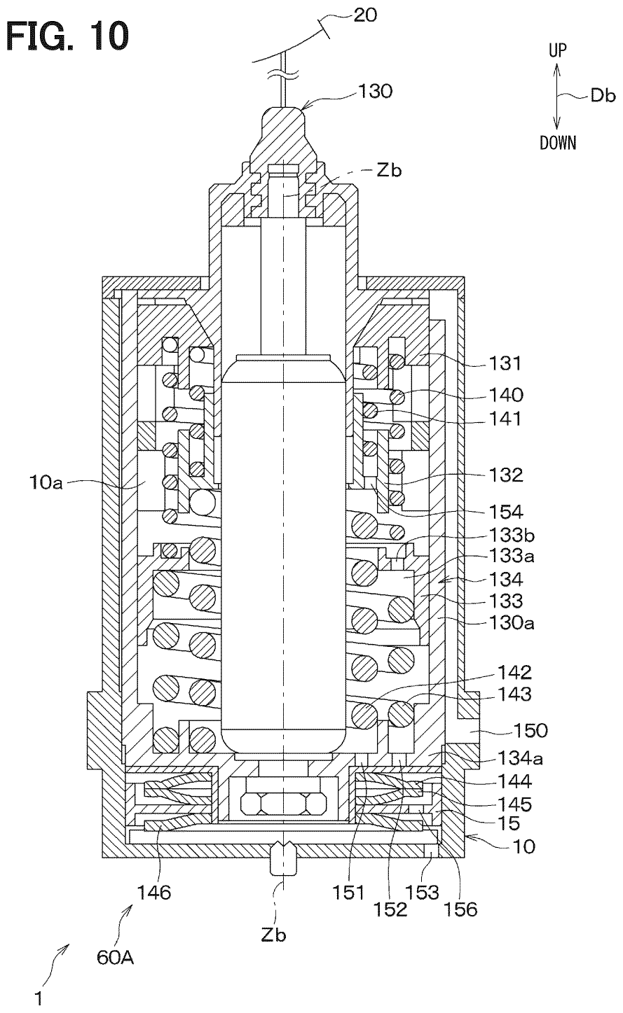

However, instead of this, the present sixth embodiment using a reaction force generator 60A using elastic members 140, 141, 142, 143, 144, 145, 146 will be described with reference to FIG. 10.

FIG. 10 is a cross-sectional view illustrating the overall configuration of the reaction force generator 60A of the present embodiment.

The reaction force generator 60A of the present embodiment includes a housing 10, a support 15, holders 130, 131, 132, 133, 134, and elastic members 140, 141, 142, 143, 144, 145, 146.

The housing 10 is formed in a cylindrical shape around the axis Zb, including an accommodation chamber 10a. The axis Zb is set to extend in the vehicle vertical direction Db.

The bottom of the housing 10 is provided with a passage 153 (i.e., a second passage) that guides foreign matter in the accommodation chamber 10a of the housing 10 to the outside of the housing 10 by gravity. The housing 10 is provided with a passage 150 that allows foreign matter in the accommodation chamber 10a to pass to the outside of the housing 10.

The holder 130 is disposed on the vehicle lower side relative to the pedal 20. The housing 10 is configured to be displaceable in the vehicle vertical direction Db. The holder 130 is configured to be able to move in the vehicle vertical direction Db. The holder 130 of the present embodiment transmits the rotational force of the pedal 20 to the holder 131.

The holder 131 is formed in an annular shape around the axis Zb. The holder 131 is disposed in the accommodation chamber 10a of the housing 10 and positioned on the vehicle lower side relative to the holder 130. The holder 131 is disposed on the radially inner side around the axis Zb relative to the holder 134.

The holder 131 of the present embodiment is configured to be displaceable in the vehicle vertical direction Db relative to the housing 10.

The holder 132 is formed in an annular shape around the axis Zb. The holder 132 is disposed in the accommodation chamber 10a of the housing 10 and positioned on the vehicle lower side relative to the holder 131. The holder 132 is disposed on the radially inner side around the axis Zb relative to the holder 134.

The holder 132 of the present embodiment is configured to be displaceable in the vehicle vertical direction Db relative to the housing 10. The holder 132 is provided with a passage 154 that guides foreign matter on the vehicle upper side of the holder 132 to the vehicle lower side of the holder 132.

The holder 133 includes a hollow 133a and is formed in a cylindrical shape around the axis Zb. The holder 133 is disposed in the accommodation chamber 10a of the housing 10 and positioned on the vehicle lower side relative to the holder 132. The holder 133 is disposed on the radially inner side around the axis Zb relative to the holder 134.

The holder 133 of the present embodiment is configured to be displaceable in the vehicle vertical direction Db relative to the housing 10. The holder 133 is provided with a passage 133b penetrating the hollow 133a from the vehicle upper side.

The holder 134 is formed in a cylindrical shape around the axis Zb. The holder 134 is disposed in the accommodation chamber 10a of the housing 10 and positioned on the radially outer side of the holder 133 around the axis Zb.

The holder 134 of the present embodiment is configured to be displaceable in the vehicle vertical direction Db relative to the housing 10. A bottom 134a of the holder 134 is provided with passages 151, 152 that guide foreign matter in the accommodation chamber 10a to the vehicle lower side of the holder 134.

The elastic member 140 is a first elastic member that is disposed in the accommodation chamber 10a of the housing 10 and positioned on the radially inner side around the axis Zb relative to the holder 134. The elastic member 140 is disposed between the holders 131, 133.

The elastic member 141 is a second elastic member disposed in the accommodation chamber 10a of the housing 10. The elastic member 141 is, for example, a coil spring disposed on the radially inner side around the axis Zb relative to the holder 134. The elastic member 141 is disposed between the holders 131, 132.

The elastic member 142 is disposed in the accommodation chamber 10a of the housing 10 and positioned on the radially inner side around the axis Zb relative to the holder 134. The elastic member 142 is disposed between the holder 132 and the bottom 134a of the holder 134.

The elastic member 143 is a second elastic member that is disposed in the accommodation chamber 10a of the housing 10 and positioned on the radially inner side around the axis Zb relative to the holder 134. The elastic member 143 is disposed between the holder 133 and the bottom 134a of the holder 134.

Each of the elastic members 140, 142, 143, 143 of the present embodiment is, for example, a coil spring formed in a spiral shape around the axis Zb.

Each of the elastic members 144, 145, 146 is disposed in the accommodation chamber 10a of the housing 10 and positioned on the vehicle lower side relative to the holder 134. The support 15 that supports the elastic member 145 from the vehicle lower side is disposed between the elastic members 145, 146. The support 15 is provided with a passage 156 that guides the foreign matter having passed through the passages 151, 152 to the vehicle lower side of the holder 134. Each of the elastic members 144, 145, 146 of the present embodiment is formed of, for example, a leaf spring.

Next, the operation of the pedal device 1 of the present embodiment will be described.

First, when the pedal force of the driver 81 is applied to the pedal 20, the pedal 20 rotates and applies a rotational force to the holder 130. Accordingly, the holder 130 is displaced to the vehicle lower side. Thus, the holder 131 is pressed by the holder 130 from the vehicle upper side and displaced to the vehicle lower side.

Therefore, the elastic member 141 is pressed by the holder 131 from the vehicle upper side while being supported by the holder 132, to be compressed through elastic deformation. In addition, the elastic member 140 is pressed by the holder 131 from the vehicle upper side while being supported by the holder 133 to be compressed through elastic deformation.

In this manner, the elastic members 140, 141 are compressed through elastic deformation to apply elastic forces to the pedal 20 via the holders 131, 130 as reaction forces against the rotational force of the pedal 20.

At this time, the elastic force of the elastic member 140 is also applied to the holder 133, whereby the holder 133 is displaced to the vehicle lower side. Thus, the elastic member 143 is pressed by the holder 134 from the vehicle upper side while being supported by the bottom 134a of the holder 133. Therefore, the elastic member 143 is compressed through elastic deformation.

The elastic force of the elastic member 141 is also applied to the holder 132, whereby the holder 132 is displaced to the vehicle lower side. Thus, the elastic member 142 is pressed by the holder 134 from the vehicle upper side while being supported by the bottom 134a of the holder 132. Therefore, the elastic member 142 is compressed through elastic deformation.

In this manner, the elastic members 142, 143 are compressed through elastic deformation to apply an elastic force to the bottom 134a of the holder 134. Accordingly, the holder 134 is displaced to the vehicle lower side. As a result, the elastic members 144, 145, 146 are pressed from the vehicle upper side by the bottom 134a of the holder 134 and compressed through elastic deformation.

When the pedal 20 swings, changing its position from the non-depressed state to the fully depressed state, the elastic members 140, 141, 142, 143, 144, 145, 146 are increasingly elastically deformed as the pedal 20 approaches the fully depressed state from the non-depressed state. For this reason, as the pedal 20 approaches the fully depressed state from the non-depressed state, the reaction force applied to the pedal 20 from the reaction force generator 60A increases.

Thereafter, when the pedal 20 is released from the foot of the driver 81 and the application of the pedal force of the driver 81 to the pedal 20 is stopped, the elastic deformation of the elastic members 140, 141, 142, 143, 144, 145, 146 returns.

In this case, with the elastic forces of the elastic members 140, 141, 142, 143, 144, 145, 146 applied to the pedal 20, the pedal 20 swings.

At this time, foreign matter such as water on the vehicle upper side of the holder 131 in the housing 10 is guided by gravity to the outside of the housing 10 by gravity through the passage 150.

Furthermore, foreign matter such as water on the vehicle upper side of the holder 132 is guided by gravity to the vehicle lower side of the holder 132 through the passage 154. Thereafter, the foreign matter such as water on the vehicle upper side of the holder 133 is guided by gravity through the passage 133b to the vehicle lower side of the holder 133 through the hollow 133a.

The foreign matter guided to the vehicle lower side of the holder 133 is guided by gravity to the bottom 134a of the holder 134. Thereafter, the guided foreign matter is guided by gravity to the bottom of the housing 10 through the passages 151, 152 at the bottom 134a of the holder 134 and the passage 156.

The guided foreign matter is guided by gravity from the bottom of the housing 10 to the vehicle lower side of the housing 10 (i.e., the outside of the accommodation chamber 10a) through the passage 153. In this manner, the foreign matter is discharged from the accommodation chamber 10a of the housing 10 to the outside of the housing 10.

According to the present embodiment described above, the pedal device 1 includes the pedal 20 that is depressed by the operator to rotate around the rotation shaft 40. The pedal device 1 includes the elastic members 140, 141, 142, 143, 144, 145, 146 that are compressed through elastic deformation by a rotational force, applied by the pedal 20 as the pedal 20 rotates, to apply elastic forces to the pedal 20 as reaction forces against the rotational force.

The pedal device 1 includes the housing 10 forming the accommodation chamber 10a that accommodates the elastic members 140, 141, 142, 143, 144, 145, 146. The housing 10 is provided with the passage 153 that guides foreign matter from the inside of the accommodation chamber 10a to the outside of the accommodation chamber 10a.

Therefore, since the foreign matter can be discharged to the outside of the housing 10, it is possible to provide the pedal device 1 capable of preventing malfunctions of the elastic members 140 to 146 caused by foreign matter such as water.

### Seventh Embodiment

In the above sixth embodiment, an example of the reaction force generator 60A using the seven elastic members 140, 141, 142, 143, 144, 145, 146 has been described.

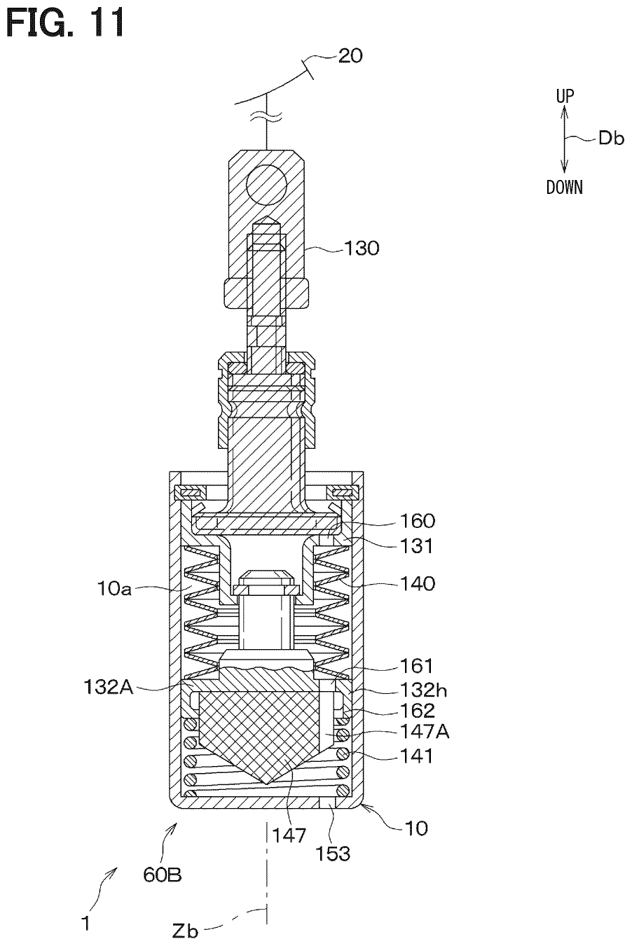

However, instead of this, the present seventh embodiment using a reaction force generator 60B with three elastic members 140, 141, 147 will be described with reference to FIG. 11.

FIG. 11 is a cross-sectional view illustrating the overall configuration of the reaction force generator 60B of the present embodiment.

The reaction force generator 60B of the present embodiment includes a housing 10, holders 130, 131, 132A, and elastic members 140, 141, 147.

The housing 10 is formed in a cylindrical shape around the axis Zb, including an accommodation chamber 10a. The bottom of the housing 10 is provided with a passage 153 that guides foreign matter in the accommodation chamber 10a of the housing 10 to the outside of the accommodation chamber 10a.

The holder 130 is disposed on the vehicle lower side relative to the pedal 20. The holder 130 is configured to be able to move in the vehicle vertical direction Db. The holder 130 of the present embodiment transmits the rotational force of the pedal 20 to the holder 131.

The holder 131 is formed in an annular shape around the axis Zb. The holder 131 is disposed in the accommodation chamber 10a of the housing 10 and positioned on the vehicle lower side relative to the holder 130.

The holder 131 of the present embodiment is configured to be displaceable in the vehicle vertical direction Db relative to the housing 10. The holder 131 is provided with a passage 160 that guides foreign matter on the vehicle upper side of the holder 131 to the vehicle lower side of the holder 131.

The holder 132A is formed in an annular shape around the axis Zb. The holder 132A is disposed in the accommodation chamber 10a of the housing 10 and positioned on the vehicle lower side relative to the holder 131. The holder 132A is provided with a holding portion 132h that holds the elastic member 147.

The holder 132A is provided with a passage 161 that allows foreign matter on the vehicle upper side of the holder 132A to pass to the vehicle lower side of the holder 132A. The holding portion 132h of the holder 132 is provided with a passage 162 that guides foreign matter on the vehicle upper side of the holding portion 132h to the vehicle lower side of the holding portion 132h.

The elastic member 140 is a first elastic member as a leaf spring disposed in the accommodation chamber 10a of the housing 10. The elastic member 140 is disposed between the holders 131, 132A.

The elastic member 141 is, for example, a coil spring. The elastic member 141 is a first elastic member disposed in the accommodation chamber 10a of the housing 10 and positioned between the holder 131 and the bottom of the housing 10.

The elastic member 147 is disposed in the accommodation chamber 10a of the housing 10 and held by the holding portion 132h of the holder 132. The elastic member 147 is provided with a passage 147A penetrating in the vehicle vertical direction Db. The passage 147A communicates with the passage 161 of the holder 132A.

The passage 147A allows foreign matter such as water, which has passed through the passage 161 of the holder 132A, to pass by gravity to the vehicle lower side of the elastic member 147. The elastic member 147 is made of rubber or the like. In the present embodiment, the passages 160, 161, 147A are arranged in the vehicle vertical direction Db.

Next, the operation of the pedal device 1 of the present embodiment will be described.

First, when the pedal force of the driver 81 is applied to the pedal 20, the pedal 20 rotates and applies a rotational force to the holder 130. Accordingly, the holder 130 is displaced to the vehicle lower side. The holder 130 presses the holder 131 from the vehicle upper side. Thus, the holder 131 is displaced to the vehicle lower side.

Therefore, the elastic member 140 is pressed by the holder 131 from the vehicle upper side while being supported by the holder 132A, to be compressed through elastic deformation. Accordingly, the elastic member 140 applies an elastic force to the pedal 20 via the holders 131, 130 as a reaction force against the rotational force of the pedal 20.

At this time, the elastic force of the elastic member 140 is also applied to the holder 132A, whereby the holder 132A is displaced to the vehicle lower side. Hence, the elastic member 141 is pressed by the holder 12A from the vehicle upper side while being supported by the bottom of the housing 10. Therefore, the elastic member 141 is compressed through elastic deformation.

In addition, as the holder 132A is displaced to the vehicle lower side, the elastic member 147 is displaced to the vehicle lower side together with the holder 132A. Thereafter, when the elastic member 147 comes into contact with the bottom of the housing 10, the elastic member is compressed through elastic deformation.

When the pedal 20 swings, changing its position from the non-depressed state to the fully depressed state, the elastic members 140, 141, 147 are increasingly elastically deformed as the pedal 20 approaches the fully depressed state from the non-depressed state. For this reason, as the pedal 20 approaches the fully depressed state from the non-depressed state, the reaction force applied to the pedal 20 from the reaction force generator 60A increases.

Thereafter, when the pedal 20 is released from the foot of the driver 81 and the application of the pedal force of the driver 81 to the pedal 20 is stopped, the elastic deformation of the elastic members 140, 141, 147 returns.

In this case, with the elastic forces of the elastic members 140, 141, 147 applied to the pedal 20, the pedal 20 swings.

At this time, foreign matter such as water on the vehicle upper side of the holder 131 is guided by gravity to the vehicle lower side of the holder 131 through the passage 160.

As described above, the foreign matter guided to the vehicle lower side of the holder 131 in this manner is guided by gravity to the bottom of the housing 10 through the passage 161 of the holder 132A and the passage 147A of the elastic member 147. Alternatively, the foreign matter is guided by gravity to the bottom of the housing 10 through the passage 162 of the holding portion 132h of the holder 132. The guided foreign matter is guided by gravity from the passage 153 at the bottom of the housing 10 to the vehicle lower side of the housing 10 (i.e., the outside of the accommodation chamber 10a).

According to the present embodiment described above, the pedal device 1 includes the elastic members 140, 141, 147 that are compressed through elastic deformation by the rotational force applied by the pedal 20 as the pedal 20 rotates. The elastic members 140, 141, 147 apply elastic forces to the pedal 20 as reaction forces against the rotational force.

The pedal device 1 includes the housing 10 forming the accommodation chamber 10a that accommodates the elastic members 140, 141, 147. The housing 10 is provided with the passage 153 that guides foreign matter from the inside of the accommodation chamber 10a to the outside of the accommodation chamber 10a.

Therefore, since the foreign matter can be discharged to the outside of the housing 10, it is possible to provide the pedal device 1 capable of preventing malfunctions of the elastic members 140 to 146 caused by foreign matter such as water.

In the present embodiment, the holder 131 is provided with the passage 160. The passages 161, 162 are provided in the holder 132A. Hence, foreign matter such as water on the vehicle upper side of the holders 131, 132A can be satisfactorily guided to the bottom of the housing 10.

### Eighth Embodiment

In the above first embodiment, an example in which the elastic members 53, 54 are arranged coaxially has been described.

However, instead of this, a pedal device 1 of the present eighth embodiment that includes a reaction force generator 60C in which three elastic members 140, 141, 142 are arranged coaxially will be described with reference to FIG. 12.

FIG. 12 is a cross-sectional view illustrating the overall configuration of the reaction force generator 60C of the present embodiment.

The reaction force generator 60C of the present embodiment includes a housing 10, a holder 130, and elastic members 140, 141, 142, 144, 145, 146.

The housing 10 is formed in a cylindrical shape around the axis Zb, including an accommodation chamber 10a. The bottom of the housing 10 is provided with a passage 153 that guides foreign matter in the accommodation chamber 10a of the housing 10 to the outside of the accommodation chamber 10a.

The holder 130 is disposed on the vehicle lower side relative to the pedal 20. The holder 130 is disposed in the accommodation chamber 10a of the housing 10. The holder 130 is configured to be able to move in the vehicle vertical direction Db.

The holder 130 of the present embodiment transmits the rotational force of the pedal 20 to the elastic members 140, 141, 142, 144, 145, 146. The holder 130 includes a shaft portion 130a extending to the vehicle lower side along the axis Zb.

Each of the elastic members 140, 141, 142 is disposed in the accommodation chamber 10a of the housing 10. Each of the elastic members 140, 141, 142 is disposed between the holder 130 and the elastic member 144.

Each of the elastic members 140, 141, 142 is, for example, a coil spring formed in a spiral shape around the axis Zb. That is, the elastic members 140, 141, 142 are arranged coaxially.

The elastic member 140 is disposed on the radially inner side around the axis Zb relative to the elastic member 141. The elastic member 141 is disposed on the radially inner side around the axis Zb relative to the elastic member 142.

The elastic member 144 is disposed on the vehicle lower side relative to the elastic members 140, 141, 142. The elastic member 145 is disposed on the vehicle lower side relative to the elastic member 144. The elastic member 146 is disposed on the vehicle lower side relative to the elastic member 145. The elastic member 146 is supported by the bottom of the housing 10.

Next, the operation of the pedal device 1 of the present embodiment will be described.

First, when the pedal force of the driver 81 is applied to the pedal 20, the pedal 20 rotates and applies a rotational force to the holder 130. Accordingly, the holder 130 is displaced to the vehicle lower side. The holder 130 presses the elastic members 140, 141, 142 from the vehicle upper side.

Therefore, the elastic members 140, 141, 142 are pressed by the holder 130 from the vehicle upper side while being supported by the elastic member 144, to be compressed through elastic deformation. Accordingly, the elastic members 140, 141, 142 apply elastic forces to the pedal 20 via the holder 130 as reaction forces against the rotational force of the pedal 20.

At this time, the elastic forces of the elastic members 140, 141, 142 are also applied to the elastic member 144. In addition, the shaft portion 130a of the holder 130 presses the elastic member 144 from the vehicle upper side. Therefore, the elastic member 144 is displaced to the vehicle lower side through elastic deformation and presses the elastic member 145 from the vehicle upper side. Accordingly, the elastic member 145 is displaced toward the vehicle lower side through elastic deformation and presses the elastic member 146 from the vehicle upper side. Hence, the elastic member 146 is deformed elastically.

When the pedal 20 swings, changing its position from the non-depressed state to the fully depressed state, the elastic members 140, 141, 142, 144, 145, 146 are increasingly elastically deformed as the pedal 20 approaches the fully depressed state from the non-depressed state. For this reason, as the pedal 20 approaches the fully depressed state from the non-depressed state, the reaction force applied by the reaction force generator 60C to the pedal 20 increases.

Thereafter, when the pedal 20 is released from the foot of the driver 81 and the application of the pedal force of the driver 81 to the pedal 20 is stopped, the elastic deformation of the elastic members 140, 141, 142, 144, 145, 146 returns.

In this case, with the elastic forces of the elastic members 140, 141, 142, 144, 145, 146 applied to the pedal 20, the pedal 20 swings.

At this time, foreign matter such as water in the accommodation chamber 10a of the housing 10 is guided by gravity from the passage 153 at the bottom of the housing 10 to the outside of the housing 10 (i.e., the outside of the accommodation chamber 10a).

According to the present embodiment described above, the pedal device 1 includes the elastic members 140, 141, 142, 144, 145, 146 that are compressed through elastic deformation by the rotational force applied by the pedal 20 as the pedal 20 rotates. The elastic members 140, 141, 142, 144, 145, 146 apply elastic forces to the pedal 20 as reaction forces against the rotational force.

The pedal device 1 includes the housing 10 forming the accommodation chamber 10a that accommodates the elastic members 140, 141, 142, 144, 145, 146. The housing 10 is provided with the passage 153 that guides foreign matter from the inside of the accommodation chamber 10a to the outside of the accommodation chamber 10a by gravity.

Therefore, since the foreign matter can be discharged by gravity to the outside of the housing 10, it is possible to provide the pedal device 1 capable of preventing malfunctions of the elastic members 140 to 146 and the holder 130 caused by foreign matter such as water.

### Ninth Embodiment

In the above first embodiment, an example in which the elastic members 53, 54 are arranged coaxially has been described.

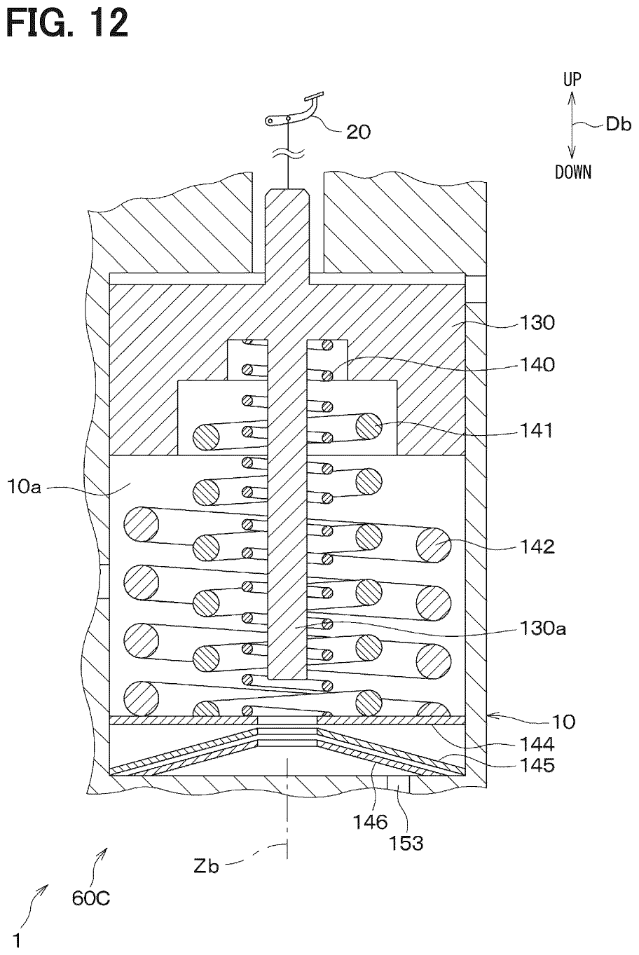

However, instead of this, a pedal device 1 of the present ninth embodiment that includes a reaction force generator 60D in which elastic members 180, 181, 182, 183, 184 are arranged in series will be described with reference to FIG. 13.

FIG. 13 is a cross-sectional view illustrating the overall configuration of the reaction force generator 60D of the present embodiment.

The reaction force generator 60B of the present embodiment includes a housing 10, holders 170, 171, 172, 173, and elastic members 180, 181, 182, 183, 184, 185.

The housing 10 includes an accommodation chamber 10a that accommodates the holders 170, 171, 172, 173, and the elastic members 180, 181, 182, 183, 184, 185. The bottom of the housing 10 is provided with a passage 153 that guides foreign matter in the accommodation chamber 10a of the housing 10 to the outside of the accommodation chamber 10a.

The holder 130 is disposed on the vehicle lower side relative to the pedal 20. The holder 130 is disposed in the accommodation chamber 10a of the housing 10. The holder 130 is configured to be displaceable in the vehicle vertical direction Db. The holder 130 of the present embodiment transmits the rotational force of the pedal 20 to the elastic member 180.

The holder 170 is disposed on the vehicle lower side of the holder 130. The holder 170 is configured to be displaceable in the vehicle vertical direction Db while being connected by the holder 130.

The holder 171 is disposed on the vehicle lower side of the holder 170. The holder 171 is configured to be displaceable in the vehicle vertical direction Db while being connected by the holder 170.

The holder 172 is disposed on the vehicle lower side of the holder 171. The holder 172 is configured to be displaceable in the vehicle vertical direction Db while being connected by the holder 171.

The holder 173 is disposed on the vehicle lower side of the holder 172. The holder 173 is configured to be displaceable in the vehicle vertical direction Db while being connected by the holder 172.

The holder 174 is disposed on the vehicle lower side of the holder 173. The holder 174 is configured to be displaceable in the vehicle vertical direction Db while being connected by the holder 173.

In this manner, the holders 170, 171, 172, 173, 174 are connected to be displaceable in the vehicle vertical direction Db while being arranged in the vehicle vertical direction Db.

The elastic member 180 is formed of, for example, a leaf spring and supported by the holder 170. The elastic member 181 is formed of, for example, a leaf spring and supported by the holder 171. The elastic member 181 is disposed on the vehicle lower side relative to the elastic member 180.

The elastic member 182 is formed of, for example, a leaf spring and supported by the holder 172. The elastic member 182 is disposed on the vehicle lower side relative to the elastic member 181.

The elastic member 183 is formed of, for example, a leaf spring and supported by the holder 173. The elastic member 183 is disposed on the vehicle lower side relative to the elastic member 182.

The elastic member 184 is formed of, for example, a leaf spring and supported by the holder 174. The elastic member 184 is disposed on the vehicle lower side relative to the elastic member 183. The elastic member 185 is formed of, for example, a coil spring and disposed between the holders 130, 172.

Next, the operation of the pedal device 1 of the present embodiment will be described.

First, when the pedal force of the driver 81 is applied to the pedal 20, the pedal 20 rotates and applies a rotational force to the holder 130. Accordingly, the holder 130 is displaced to the vehicle lower side. The holder 130 presses the elastic member 180 from the vehicle upper side. Therefore, the elastic member 180 is pressed by the holder 130 from the vehicle upper side to be compressed through elastic deformation. Accordingly, the elastic member 180 applies an elastic force to the pedal 20 via the holder 130 as a reaction force against the rotational force of the pedal 20.

At this time, the elastic force of the elastic member 180 is also applied to the holder 170, whereby the holder 170 is displaced to the vehicle lower side. Therefore, the elastic member 181 is pressed by the holder 170 from the vehicle upper side. As a result, the elastic member 181 is compressed through elastic deformation.

Furthermore, the elastic force of the elastic member 181 is also applied to the holder 171, whereby the holder 171 is displaced to the vehicle lower side. Therefore, the elastic member 182 is pressed by the holder 171 from the vehicle upper side. Accordingly, the elastic member 182 is compressed through elastic deformation.

At this time, the elastic force of the elastic member 182 is also applied to the holder 172, whereby the holder 172 is displaced to the vehicle lower side. Therefore, the elastic member 183 is pressed by the holder 172 from the vehicle upper side. Accordingly, the elastic member 183 is compressed through elastic deformation.

At this time, the elastic force of the elastic member 183 is also applied to the holder 173, whereby the holder 173 is displaced to the vehicle lower side.

Therefore, the elastic member 184 is pressed by the holder 174 from the vehicle upper side while being supported by the bottom of the housing 10 via the holder 173. Accordingly, the elastic member 183 is compressed through elastic deformation.

Furthermore, as the holders 130, 172 are each displaced, the elastic member 185 receives forces in the vehicle vertical direction Db from the holders 130, 172 and is compressed through elastic deformation.

When the pedal 20 swings, changing its position from the non-depressed state to the fully depressed state, the elastic members 180, 181, 182, 183, 184, 185 are increasingly elastically deformed as the pedal 20 approaches the fully depressed state from the non-depressed state. For this reason, as the pedal 20 approaches the fully depressed state from the non-depressed state, the reaction force applied by the reaction force generator 60D to the pedal 20 increases.

Thereafter, when the pedal 20 is released from the foot of the driver 81 and the application of the pedal force of the driver 81 to the pedal 20 is stopped, the elastic deformation of the elastic members 180, 181, 182, 183, 184, 185 returns.

In this case, with the elastic forces of the elastic members 180, 181, 182, 183, 184, 185 applied to the pedal 20, the pedal 20 swings.

At this time, foreign matter in the accommodation chamber 10a of the housing 10 is guided by gravity from the passage 153 at the bottom of the housing 10 to the outside of the housing 10 (i.e., the outside of the accommodation chamber 10a).

According to the present embodiment described above, the pedal device 1 includes the elastic members 180, 181, 182, 183, 184, 185 that are compressed through elastic deformation by the rotational force applied by the pedal 20 as the pedal 20 rotates. The elastic members 180, 181, 182, 183, 184, 185 apply elastic forces to the pedal 20 as reaction forces against the rotational force.

The pedal device 1 includes the housing 10 forming the accommodation chamber 10a that accommodates the elastic members 180, 181, 182, 183, 184, 185 and the holders 170, 171, 172, 173. The housing 10 is provided with a passage 153 that guides foreign matter from the inside of the accommodation chamber 10a to the outside of the housing 10.

Therefore, since the foreign matter can be discharged to the outside of the housing 10, it is possible to provide the pedal device 1 capable of preventing malfunctions of the elastic members 180, 181, 182, 183, 184, 185 and the holder 130 caused by foreign matter such as water.

### Tenth Embodiment

In the above ninth embodiment, an example has been described in which the reaction force generator 60D with the elastic members 180, 181, 182, 183, 184 arranged in series is provided.

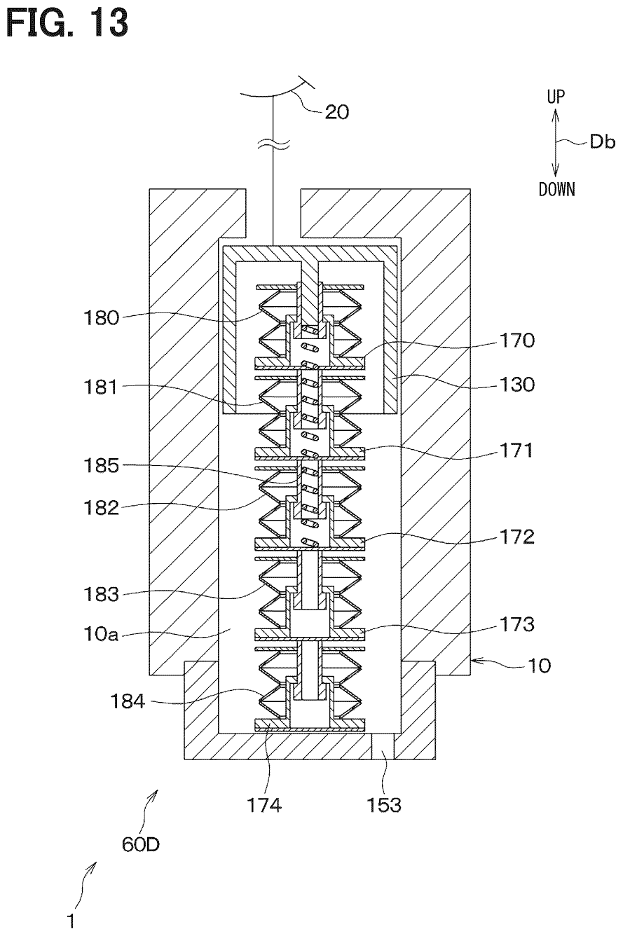

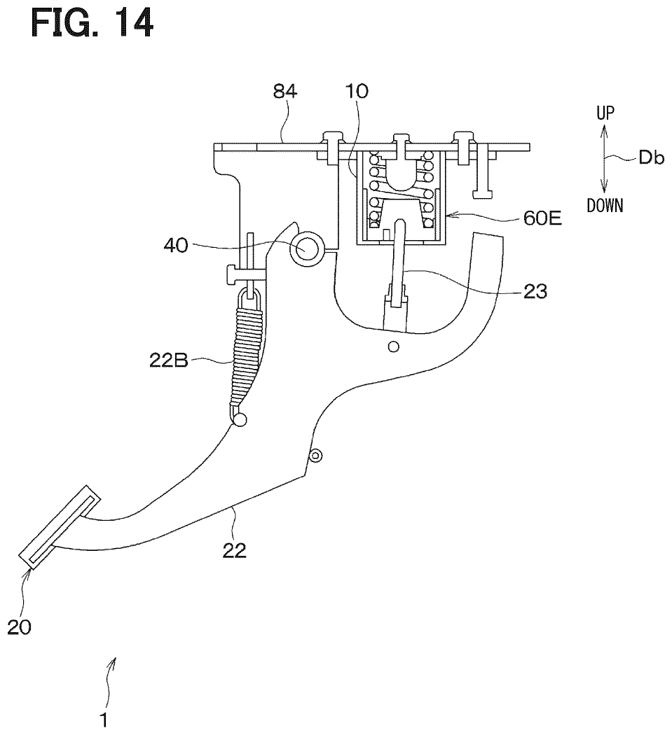

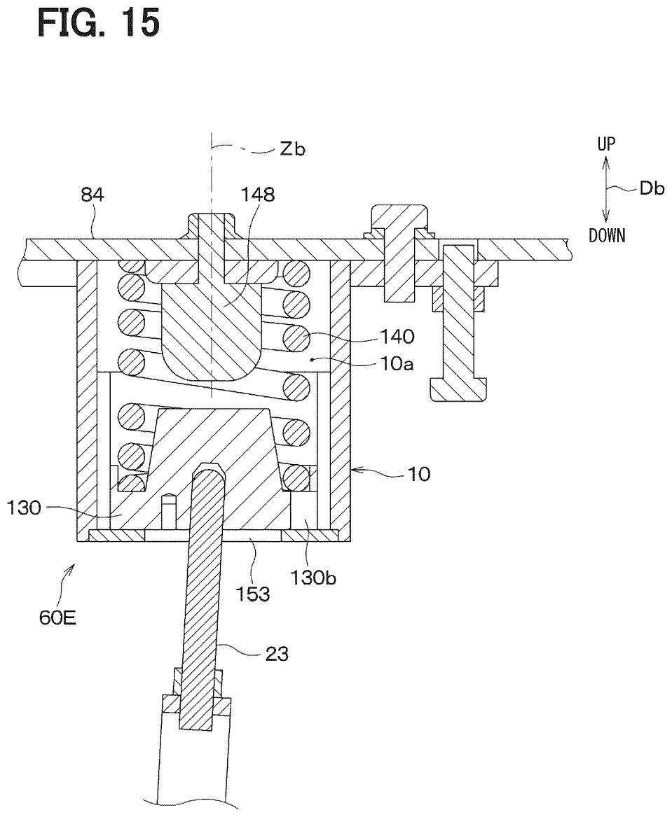

However, instead of this, a pedal device 1 of the present tenth embodiment that includes a reaction force generator 60E using two elastic members 140, 148 will be described with reference to FIGS. 14 and 15.

FIG. 14 is a cross-sectional view illustrating the overall configuration of the pedal device 1 of the present embodiment. FIG. 15 is a cross-sectional view illustrating a detailed configuration of the reaction force generator 60E in FIG. 14.

As illustrated in FIGS. 14 and 15, the pedal device 1 of the present embodiment includes a pedal 20, a pedal arm 22, a link member 23, a rotation shaft 40, the reaction force generator 60E, and an elastic member 22B.

As illustrated in FIG. 15, the reaction force generator 60E includes a housing 10, a holder 130, and the elastic members 140, 148.

The pedal 20 is supported by a pedal arm 22. The pedal arm 22 is supported by a vehicle body 84 to be rotatable around a rotation shaft 40. As a result, the pedal 20 is configured to be rotatable around the rotation shaft 40.

The link member 23 is formed in a rod shape. One end side of the link member 23 is connected to the pedal arm 22. The other end side of the link member 23 is connected to the holder 130 of the reaction force generator 60E.

The housing 10 is supported by the vehicle body 84. The housing 10 includes an accommodation chamber 10a that accommodates the elastic members 140, 148 and the holder 130. The housing 10 includes an opening that opens to the vehicle upper side, and the opening is closed by the vehicle body 84. The bottom of the housing 10 is provided with a passage 153 that guides foreign matter in the accommodation chamber 10a of the housing 10 to the outside of the accommodation chamber 10a.

The elastic member 140 is, for example, a coil spring formed in a spiral shape around the axis Zb. The elastic member 140 is disposed between the vehicle body 84 and the bottom of the housing 10. The elastic member 148 is made of an elastic member such as rubber and is configured to be projected toward the vehicle lower side.

The holder 130 is configured to be displaceable in the vehicle vertical direction Db. The holder 130 is provided with a passage 130b that guides foreign matter such as water on the vehicle upper side of the holder 130 to the vehicle lower side of the holder 130 by gravity.

One end portion of the elastic member 22B of the present embodiment is connected to the pedal arm 22, and the other end portion of the elastic member 22B is connected to the vehicle body 84.

Next, the operation of the pedal device 1 of the present embodiment will be described.

First, when the pedal force of the driver 81 is applied to the pedal 20, the pedal arm 22 rotates and the rotational force is applied to the holder 130 through the link member 23 while the elastic member 22B is expanded through elastic deformation. Accordingly, the holder 130 is displaced to the vehicle upper side.

When the pedal 20 is displaced to the vehicle upper side in this manner, the holder 130 opens the passage 153 of the housing 10.

The holder 130 presses the elastic member 140 from the vehicle lower side. Therefore, the elastic member 140 is pressed by the holder 130 from the vehicle upper side while being supported by the vehicle body 84, to be compressed through elastic deformation. At this time, the holder 130 presses the elastic member 148 from the vehicle lower side. As a result, the elastic member 148 is compressed through elastic deformation.

As described above, the elastic members 140, 148 are compressed through elastic deformation, whereby the elastic members 140, 148 apply elastic forces to the holder 130. Therefore, the elastic members 140, 148 apply elastic forces to the pedal 20 via the holder 130, the pedal arm 22, and the link member 23 as reaction forces against the rotational force of the pedal 20.

When the pedal 20 swings, changing its position from the non-depressed state to the fully depressed state, the elastic members 140, 148 are increasingly elastically deformed as the pedal 20 approaches the fully depressed state from the non-depressed state.

For this reason, as the pedal 20 approaches the fully depressed state from the non-depressed state, the reaction force applied by the reaction force generator 60E to the pedal 20 increases.

Thereafter, when the pedal 20 is released from the foot of the driver 81 and the application of the pedal force of the driver 81 to the pedal 20 is stopped, the elastic deformation of the elastic members 140, 148, 22B returns.

In this case, with the elastic forces of the elastic members 140, 148 applied to the pedal 20, the pedal 20 swings.

When the pedal 20 is in the non-depressed state as described above, the holder 130 closes the passage 153 of the housing 10.

At this time, foreign matter on the vehicle upper side of the holder 130 in the accommodation chamber 10a is guided to the vehicle lower side of the holder 130 through the passage 130b.

With the holder 130 opening the passage 153 of the housing 10, the foreign matter guided to the vehicle lower side of the holder 130 is guided to the outside of the housing 10 (i.e., the outside of the accommodation chamber 10a) through the passage 153 at the bottom of the housing 10.

According to the present embodiment described above, the pedal device 1 includes the elastic members 140, 148 that are compressed through elastic deformation by the rotational force, applied by the pedal 20 as the pedal 20 rotates, to apply elastic forces to the pedal 20 as reaction forces against the rotational force.

The pedal device 1 includes the housing 10 forming the accommodation chamber 10a that accommodates the elastic members 140, 148. The housing 10 is provided with a passage 153 that guides foreign matter from the inside of the accommodation chamber 10a to the outside of the housing 10.

Therefore, since the foreign matter can be discharged to the outside of the housing 10, it is possible to provide the pedal device 1 capable of preventing malfunctions of the elastic members 140, 148 caused by foreign matter such as water.

In the present embodiment, the holder 130 is provided with the passage 130b. Hence, foreign matter such as water on the vehicle upper side of the holder 130 can be satisfactorily guided by gravity to the vehicle lower side of the holder 130.

### Eleventh Embodiment

In the above tenth embodiment, an example has been described in which the reaction force generator 60E using the elastic member 148 made of an elastic material such as rubber is provided.

However, instead of this, a pedal device 1 of the present eleventh embodiment that includes a reaction force generator 60F using an elastic member 148 formed of a torsion spring will be described with reference to FIG. 16.

FIG. 16 is a cross-sectional view illustrating the overall configuration of the pedal device 1 of the present embodiment.

As illustrated in FIG. 16, the pedal device 1 of the present embodiment includes a pedal 20, a pedal arm 22, and the reaction force generator 60F.

The reaction force generator 60F includes a housing 10, elastic members 140, 149, a link member 25, and a rotation shaft 40.

The pedal 20 is supported by a pedal arm 22. The pedal arm 22 is configured to be displaceable in the vehicle travel direction Da.

As a result, the pedal 20 is configured to be displaceable in the vehicle travel direction Da. The pedal arm 22 transmits the pedal force of the driver 81 applied to the pedal 20 to the link member 25.

The housing 10 includes an accommodation chamber 10a that accommodates the elastic members 140, 149, the link member 25, and the rotation shaft 40. The housing 10 is provided with a passage 153 that guides foreign matter in the accommodation chamber 10a of the housing 10 to the outside of the accommodation chamber 10a by gravity. The housing 10 is provided with an opening 155 that opens to the front side of the vehicle and allows the link member 25 to pass through.

The link member 25 is configured to be rotatable around the rotation shaft 40. The rotation of the link member 25 transmits the pedal force of the driver 81 transmitted from the pedal arm 22 to the elastic member 140.

The elastic member 140 is, for example, a coil spring formed in a spiral shape around the axis Zb. The axis Zb is an imaginary line extending in the axial direction Dz, which intersects the vehicle travel direction Da and intersects the vehicle vertical direction Db. The elastic member 140 is disposed between the ceiling portion of the housing 10 and the link member 25.

The elastic member 149 is a torsion spring that applies an elastic force to the link member 25 toward one side in the rotation direction Dk around the rotation shaft 40 while being supported by the housing 10. The elastic member 149 applies its elastic force to the elastic member 140 via the link member 25 to hold the elastic member 140 on the vehicle upper side relative to the link member 25.

Next, the operation of the pedal device 1 of the present embodiment will be described.

First, when the pedal force of the driver 81 is applied to the pedal 20, the pedal arm 22 is displaced to the front side of the vehicle, and the pedal force of the driver 81 is applied to the link member 25 through the pedal arm 22. Accordingly, the link member 25 rotates to one side in the rotation direction Dk.

As a result, the link member 25 presses the elastic member 140 from one side in the axial direction Dz. Thus, the elastic member 140 is pressed from one side in the axial direction Dz by the link member 25 while being supported by the ceiling portion of the housing 10, to be compressed through elastic deformation.

As described above, the elastic member 140 is compressed through elastic deformation, whereby the elastic member 140 applies an elastic force to the link member 25. Therefore, the elastic member 140 applies an elastic force to the pedal 20 via the link member 25 and the pedal arm 22 as a reaction force against the rotational force of the pedal 20.

When the pedal 20 swings, changing its position from the non-depressed state to the fully depressed state, the elastic member 140 is increasingly elastically deformed as the pedal 20 approaches the fully depressed state from the non-depressed state. For this reason, as the pedal 20 approaches the fully depressed state from the non-depressed state, the reaction force applied by the reaction force generator 60F to the pedal 20 increases.

Thereafter, when the pedal 20 is released from the foot of the driver 81 and the application of the pedal force of the driver 81 to the pedal 20 is stopped, the elastic deformation of the elastic member 140 returns.

In this case, with the elastic force of the elastic member 140 applied to the link member 25, the link member 25 swings to the other side in the rotation direction Dk. Accordingly, the pedal arm 22 is pushed toward the front side of the vehicle by the link member 25. As a result, the pedal 20 is displaced to the front side of the vehicle together with the pedal arm 22.

At this time, foreign matter in the accommodation chamber 10a of the housing 10 is guided by gravity from the passage 153 at the bottom of the housing 10 to the outside of the housing 10 (i.e., the outside of the accommodation chamber 10a).

According to the present embodiment described above, the pedal device 1 includes the elastic member 140 that is compressed through elastic deformation by the rotational force, applied by the pedal 20 as the pedal 20 rotates, to apply an elastic force to the pedal 20 as a reaction force against the rotational force.

The pedal device 1 includes the housing 10 forming the accommodation chamber 10a that accommodates the elastic member 140. The housing 10 is provided with the passage 153 that guides foreign matter from the inside of the accommodation chamber 10a to the outside of the accommodation chamber 10a by gravity.

Therefore, since the foreign matter can be discharged to the outside of the housing 10, it is possible to provide the pedal device 1 capable of preventing malfunctions of the elastic members 140, 148 caused by foreign matter such as water.

### Twelfth Embodiment

In the above eleventh embodiment, an example has been described in which the reaction force generator 60E using a torsion spring is provided.

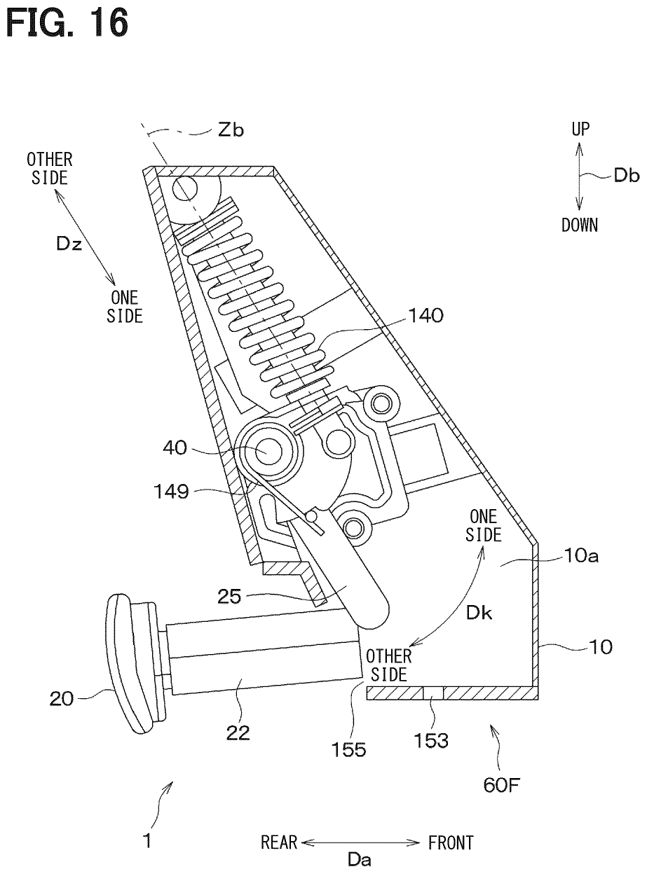

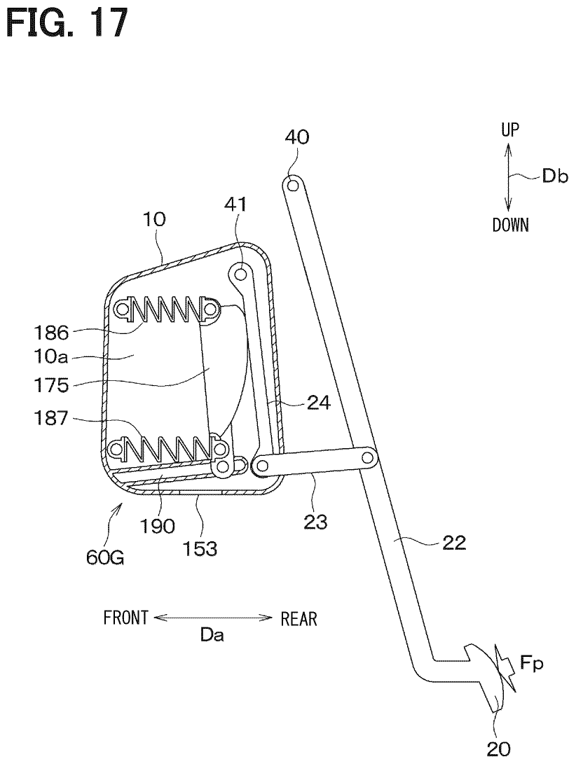

However, instead of this, a pedal device 1 of the present twelfth embodiment that includes a reaction force generator 60G using two coil springs will be described with reference to FIG. 17.

FIG. 17 is a cross-sectional view illustrating the overall configuration of the pedal device 1 of the present embodiment.

As illustrated in FIG. 17, the pedal device 1 of the present embodiment includes a pedal 20, a pedal arm 22, a link member 23, and the reaction force generator 60G.

The reaction force generator 60G includes a housing 10, a link member 24, a rotation shaft 41, a holder 175, elastic members 186, 187, and a guide 190.

The pedal 20 is supported by a pedal arm 22. The pedal arm 22 is configured to be rotatable around a rotation shaft 40.

As a result, the pedal 20 is configured to be rotatable around the rotation shaft 40. The pedal arm 22 transmits the pedal force of the driver 81 applied to the pedal 20 to the link member 23.

One end side of the link member 23 is rotatably connected to the pedal arm 22. The other end side of the link member 23 is rotatably connected to the link member 24 of the reaction force generator 60F.

The housing 10 includes an accommodation chamber 10a that accommodates the link member 24, the rotation shaft 41, the elastic members 186, 187, and the guide 190. The housing 10 is provided with a passage 153 that guides foreign matter in the accommodation chamber 10a of the housing 10 to the outside of the accommodation chamber 10a.

The link member 24 is configured to be rotatable around the rotation shaft 41. The rotation shaft 41 is supported by the housing 10.

The holder 175 is supported by the guide 190 to be displaceable in the vehicle travel direction Da. The guide 190 is supported by the housing 10 and configured to allow the holder 175 to be displaced in the vehicle travel direction Da.

The elastic members 186, 187 support the holder 175 while being supported by the inner wall of the housing 10.

Next, the operation of the pedal device 1 of the present embodiment will be described.

First, when the pedal force of the driver 81 is applied to the pedal 20, the pedal arm 22 rotates to one side in the rotation direction around the rotation shaft 40, and the pedal force of the driver 81 is applied to the link member 24 through the pedal arm 22 and the link member 23. Accordingly, the link member 24 rotates to one side in the rotation direction via the rotation shaft 41.

Accordingly, the link member 24 presses the holder 175 toward the front side of the vehicle. Therefore, each of the elastic members 186, 187 is pressed from the rear side of the vehicle by the holder 175 while being supported by the inner wall of the housing 10, to be compressed through elastic deformation.

As described above, the elastic members 186, 187 are compressed through elastic deformation, whereby the elastic members 186, 187 apply elastic forces to the holder 175. Thus, the elastic forces of the elastic members 186, 187 are applied to the pedal 20 through the holder 175, the link members 24, 23, and the pedal arm 22.

When the pedal 20 swings, changing its position from the non-depressed state to the fully depressed state, the elastic members 186, 187 are increasingly elastically deformed as the pedal 20 approaches the fully depressed state from the non-depressed state. For this reason, as the pedal 20 approaches the fully depressed state from the non-depressed state, the reaction force applied by the reaction force generator 60G to the pedal 20 increases.

Thereafter, when the pedal 20 is released from the foot of the driver 81 and the application of the pedal force of the driver 81 to the pedal 20 is stopped, the elastic deformation of the elastic members 186, 187 returns.

In this case, with the elastic forces of the elastic members 186, 187 applied to the holder 175, the holder 175 is displaced to the rear side of the vehicle. Accordingly, the link members 24, 23 rotate to the other side in the rotation direction together with the pedal arm 22. As a result, the pedal 20 rotates to the other side in the rotation direction together with the pedal arm 22.

At this time, foreign matter in the accommodation chamber 10a of the housing 10 is guided by gravity from the passage 153 at the bottom of the housing 10 to the outside of the housing 10 (i.e., the outside of the accommodation chamber 10a).

According to the present embodiment described above, the pedal device 1 includes the elastic members 186, 187 that are compressed through elastic deformation by the rotational force, applied by the pedal 20 as the pedal 20 rotates, to apply elastic forces to the pedal 20 as reaction forces against the rotational force.

The pedal device 1 includes the housing 10 forming the accommodation chamber 10a that accommodates the elastic members 186, 187. The housing 10 is provided with the passage 153 that guides foreign matter from the inside of the accommodation chamber 10a to the outside of the accommodation chamber 10a by gravity.

Therefore, since the foreign matter can be discharged to the outside of the housing 10, it is possible to provide the pedal device 1 capable of preventing malfunctions of the elastic members 186, 187 caused by foreign matter such as water.

### Thirteenth Embodiment

In the above first embodiment, an example of the reaction force generator 50 using the two holders 51, 52 has been described.

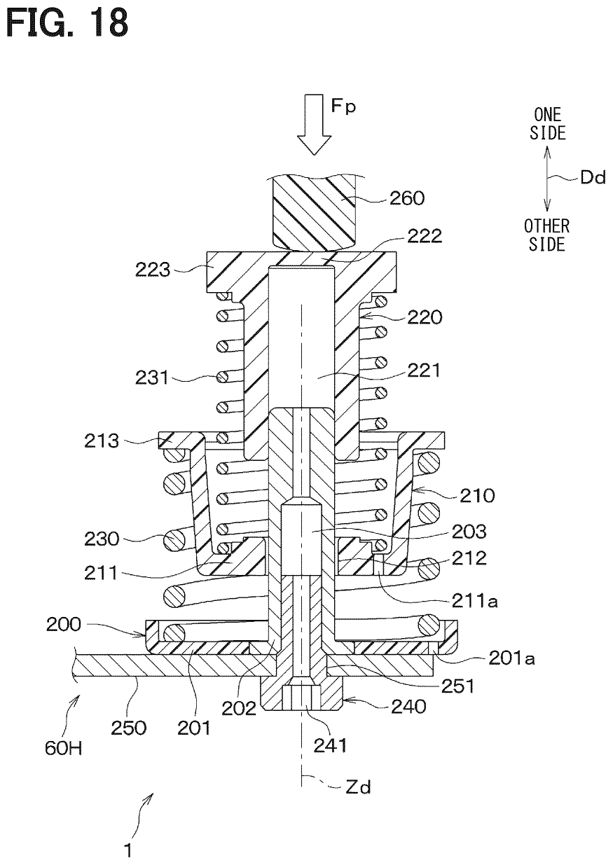

However, instead of this, a pedal device 1 of the present thirteenth embodiment that includes a reaction force generator 60H using three holders will be described with reference to FIG. 18.

FIG. 18 is a cross-sectional view illustrating the overall configuration of the reaction force generator 60H in the pedal device 1 of the present embodiment.

As illustrated in FIG. 18, the reaction force generator 60H of the present embodiment includes holders 200, 210, 220, elastic members 230, 231, a fastening member 240, and a leaf spring 250.

The holder 200 includes a support 201 and a guide portion 202. The support 201 is formed in a substantially disk shape around an axis Zd. The support 201 is disposed on one side in an axial direction Dd relative to the leaf spring 250.

The guide portion 202 is formed to extend from the support 201 to one side in the axial direction Dd along the axis Zd. In the guide portion 202, a hollow 203 penetrating in the axial direction Dd is formed.

The holder 200 of the present embodiment is provided with a passage 201a that guides foreign matter on the vehicle upper side of the holder 200 to the vehicle lower side of the holder 200.

The fastening member 240 is fastened to the guide portion 202 through the hollow 203 of the guide portion 202 while penetrating the through hole 251 of the leaf spring 250. As a result, the fastening member 240 fastens the leaf spring 250 and the holder 200 to each other. In the fastening member 240 of the present embodiment, a passage 241 penetrating in the axial direction Dd is formed.

The leaf spring 250 is configured to be displaceable to the other side in the axial direction Dd through elastic deformation while being supported by the vehicle body. The axial direction Dd is a direction in which the axis Zd extends.

The holder 210 includes a bottom 211 and is formed in a cup shape around the axis Zd. A through hole 212 penetrating in the axial direction Dd is provided at the bottom 211 of the holder 210.

In the holder 210, the guide portion 202 of the holder 200 penetrates the through hole 212. The holder 210 is configured to be displaceable in the vehicle vertical direction Db by being guided by the guide portion 202.

On one side of the holder 210 in the axial direction Dd, a flange 213 protruding radially outward around the axis Zd is provided. The bottom 211 of the holder 210 of the present embodiment is provided with a passage 211a that guides foreign matter on the vehicle upper side of the holder 210 to the vehicle lower side of the holder 210.

The holder 220 includes a hollow 221 and is formed in a cylindrical shape around the axis Zd. The holder 220 is provided with a lid 222 that closes the hollow 221 from one side in the axial direction Dd. On one side of the holder 220 in the axial direction Dd, a flange 223 protruding radially outward around the axis Zd is provided.

In the holder 220 of the present embodiment, the guide portion 202 of the holder 200 is placed in the hollow 221. The holder 220 is configured to be displaceable in the axial direction Dd by being guided by the guide portion 202.

The elastic member 230 is, for example, a coil spring formed in a spiral shape around the axis Zd. The elastic member 230 is a first elastic member that supports the flange 213 of the holder 200 while being supported by the holder 210.

The elastic member 231 is, for example, a coil spring formed in a spiral shape around the axis Zd. The elastic member 231 is a second elastic member that supports the flange 223 of the holder 210 while being supported by the bottom 211 of the holder 220.

Next, the operation of the pedal device 1 of the present embodiment will be described.

First, when the pedal force of the driver 81 is applied to the pedal, the pedal rotates to one side in the rotation direction around the rotation shaft, and the pedal force of the driver 81 is transmitted to the holder 220 through a rod 260.

At this time, the rod 260 presses the holder 220 toward the vehicle lower side. Therefore, the holder 220 is guided by the guide portion 202 of the holder 210 while being supported by the bottom 211 of the holder 200, and is displaced to the vehicle lower side.

Accordingly, the holder 220 presses the elastic member 231 toward the vehicle lower side. Thus, the elastic member 231 is compressed through elastic deformation.

At this time, the elastic force of the elastic member 231 is applied to the pedal through the rod 260 as a reaction force against the pedal force of the driver 81.

At this time, the elastic force of the elastic member 231 is applied to the bottom 211 of the holder 210. Therefore, the holder 210 is guided by the guide portion 202 of the holder 200 and displaced to the vehicle lower side.

Accordingly, the holder 210 presses the elastic member 230 toward the vehicle lower side. Hence, the elastic member 230 is compressed through elastic deformation while being supported by the leaf spring 250 via the holder 200.

As described above, the elastic member 230 is compressed through elastic deformation, whereby the elastic member 230 applies an elastic force to each of the holder 210 and the holder 200. At this time, the holder 200 receives the elastic force of the elastic member 230 and is displaced to the vehicle lower side.

Thus, the leaf spring 250 is pressed from the vehicle upper side by the holder 200 to be elastically deformed and displaced to the vehicle lower side.

When the pedal 20 swings, changing its position from the non-depressed state to the fully depressed state, the elastic members 230, 231, 232 and the leaf spring 250 are increasingly elastically deformed as the pedal approaches the fully depressed state from the non-depressed state. For this reason, as the pedal approaches the fully depressed state from the non-depressed state, the reaction force applied by the reaction force generator 60H to the pedal increases.

Thereafter, when the pedal is released from the foot of the driver 81 and the application of the pedal force of the driver to the pedal is stopped, the elastic deformation of the elastic members 230, 231, 232 and the leaf spring 250 returns.

At this time, foreign matter on the vehicle upper side of the holder 210 is guided by gravity to the vehicle lower side of the holder 210 through the passage 211a. The guided foreign matter is guided by gravity from the vehicle upper side of the holder 200 to the vehicle lower side of the holder 200 through the passage 201a.

Furthermore, the foreign matter in the hollow 221 of the holder 220 is guided by gravity to the vehicle lower side of the fastening member 240 through the hollow 203 of the guide portion 202 and the passage 241 of the fastening member 240.

According to the present embodiment described above, in the reaction force generator 60H, the holder 210 is provided with the passage 211a that guides foreign matter on the vehicle upper side of the holder 210 to the vehicle lower side of the holder 210 by gravity. This can prevent a malfunction of the elastic member 231 caused by foreign matter such as water.

The holder 200 is provided with the passage 201a that guides foreign matter on the vehicle upper side of the holder 200 to the vehicle lower side of the holder 200 by gravity. Accordingly, it is possible to provide the pedal device 1 configured to prevent malfunctions of the elastic members 231, 230 and the holders 210, 220 caused by foreign matter such as water.

### Fourteenth Embodiment

In the above thirteenth embodiment, an example in which the holders 220, 210 are displaced by being guided by the guide portion 202 has been described.

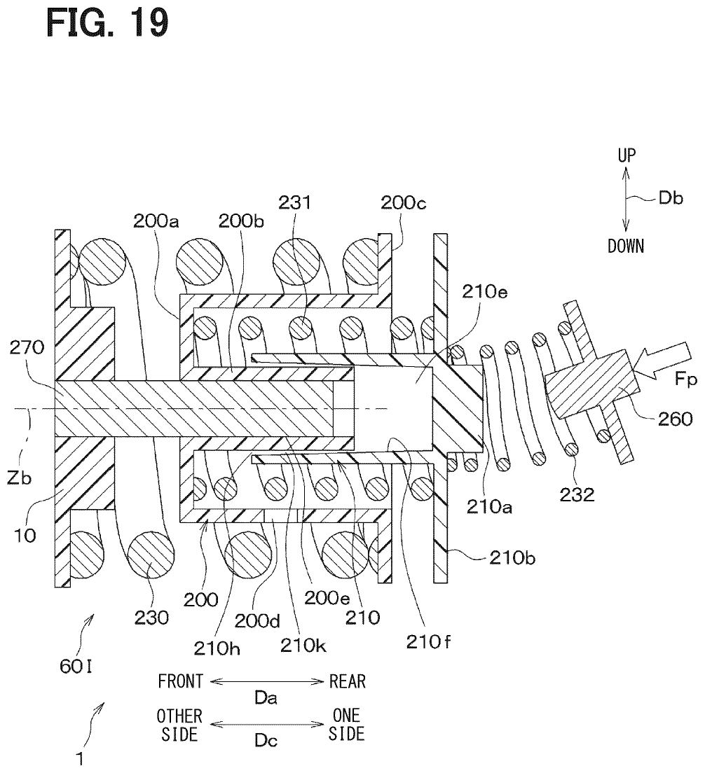

However, instead of this, with reference to FIG. 19, a description will be given of a pedal device 1 of the present fourteenth embodiment that includes a reaction force generator 60I, in which the holder 200 is guided by the guide portion 270 and displaced, and the holder 210 is guided by the holder 200 and displaced.

FIG. 19 is a cross-sectional view illustrating the overall configuration of the reaction force generator 60I in the pedal device 1 of the present embodiment.

As illustrated in FIG. 19, the reaction force generator 60I of the present embodiment includes holders 200, 210, elastic members 230, 231, 232, and a guide portion 270.

The holder 200 includes a bottom 200a and is formed in a cup shape around the axis Zd. The bottom 200a is provided with a cylindrical portion 200b including a hollow 200e and formed in a cylindrical shape around the axis Zd. The axis Zb of the present embodiment is an imaginary line extending in the vehicle travel direction Da.

The guide portion 270 penetrates the cylindrical portion 200b. The holder 200 is configured to be displaceable in the vehicle travel direction Da while being guided by the guide portion 270. The guide portion 270 is formed in a columnar shape around the axis Zb. The guide portion 270 guides the displacement of the holder 200 while being supported by a housing 10.

The holder 200 is provided with a flange 200c protruding radially outward around the axis Zd. The holder 200 of the present embodiment is provided with a passage 200d that guides foreign matter from the hollow 200e to the vehicle lower side of the holder 200.

The holder 210 includes a hollow 210e and is formed in a cylindrical shape around the axis Zb. The holder 210 is provided with a lid 210a that closes the hollow 210e from the rear side of the vehicle. The holder 210 is provided with a flange 210b protruding radially outward around the axis Zb. The holder 210 is configured to be displaceable in the vehicle travel direction Da while being guided by the cylindrical portion 200b in a state where the cylindrical portion 200b of the holder 200 is inserted into the hollow 210e.

An inner peripheral surface 210f of the holder 210 around the axis Zb includes a passage 210k recessed radially outward around the axis Zb. The passage 210k includes an outlet 210h that opens to the other side in the axial direction Dc.

The inner peripheral surface 210f of the holder 210 is formed to extend radially outward around the axis Zb as the inner peripheral surface 210f approaches the other side of the holder 210 in the axial direction Dc from the one side in the axial direction Dc. That is, the inner peripheral surface 210f of the holder 210 is formed in an inclined shape radially outward around the axis Zb as the inner peripheral surface 210f approaches the outlet 210h from one side of the holder 210 in the axial direction Dc.

In the present embodiment, the inner peripheral surface 210f of the holder 210 is formed in an inclined shape radially outward from one side in the axial direction Dc toward the outlet 210h over the entire circumferential direction around the axis Zb.

In a part of the inner peripheral surface 210f of the holder 210 in the circumferential direction around the axis Zb, the inner peripheral surface may be formed in an inclined shape radially outward from one side in the axial direction Dc toward the outlet 210h. The inner peripheral surface 210f may be formed with a draft angle for molding the hollow 210e when the holder 210 is injection-molded using a metal material or a resin material.

The elastic member 230 is, for example, a coil spring formed in a spiral shape around the axis Zd. The elastic member 230 is a first elastic member that supports the flange 200c of the holder 200 while being supported by the housing 10.

The elastic member 231 is, for example, a coil spring formed in a spiral shape around the axis Zd. The elastic member 231 is a first elastic member that supports the flange 210b of the holder 210 while being supported by the bottom 200a of the holder 200.

The elastic member 232 is, for example, a coil spring formed in a spiral shape. The elastic member 232 supports the rod 260 while being supported by the flange 210b of the holder 210.

Next, the operation of the pedal device 1 of the present embodiment will be described.

First, when the pedal force of the driver 81 is applied to the pedal, the pedal rotates to one side in the rotation direction around the rotation shaft, and the pedal force of the driver 81 is transmitted to the elastic member 232 through the rod 260. At this time, the rod 260 presses the elastic member 232 from the rear side of the vehicle.

Accordingly, the elastic member 232 is compressed through elastic deformation while being supported by the flange 210b of the holder 210. Thus, the elastic force of the elastic member 232 is applied to the pedal via the rod 260 as a reaction force against the pedal force of the driver 81.

At this time, the holder 210 receives the elastic force of the elastic member 232 to be guided by the cylindrical portion 200b of the holder 200 and displaced to the front side of the vehicle.

Accordingly, the elastic member 231 is pressed by the holder 210 from the rear side of the vehicle. Hence, the elastic member 231 is compressed through elastic deformation while being supported by the bottom 200a of the holder 200.

As described above, the elastic member 231 is compressed through elastic deformation, whereby the elastic member 231 applies an elastic force to the flange 210b of the holder 210.

At this time, the holder 200 receives the elastic force of the elastic member 231 to be guided by the guide portion 270 and displaced to the front side of the vehicle. Hence, the elastic member 230 is pressed against the front side of the vehicle by the flange 200c of the holder 200. Accordingly, the elastic member 230 is compressed through elastic deformation.

When the pedal 20 swings, changing its position from the non-depressed state to the fully depressed state, the elastic members 230, 231, 232 are increasingly elastically deformed as the pedal approaches the fully depressed state from the non-depressed state. For this reason, as the pedal approaches the fully depressed state from the non-depressed state, the reaction force applied by the reaction force generator 60I to the pedal increases.

Thereafter, when the pedal is released from the foot of the driver 81 and the application of the pedal force of the driver to the pedal is stopped, the elastic deformation of the elastic members 230, 231, 232 returns.

At this time, foreign matter inside the holder 200 is guided by gravity to the vehicle lower side of the holder 210 through the passage 200d.

According to the present embodiment described above, in the reaction force generator 60I, the holder 200 is provided with the passage 200d that guides the foreign matter inside the holder 200 to the vehicle lower side of the holder 200 by gravity. This can prevent malfunctions of the holder 200 and the elastic member 231 caused by foreign matter such as water.

Therefore, it is possible to provide the pedal device 1 configured to prevent malfunctions of the holder 200 and the elastic member 231 caused by foreign matter such as water.

In the present embodiment, the inner peripheral surface 210f of the holder 210 is formed to extend radially outward around the axis Zb as the inner peripheral surface 210f approaches the outlet 210h of the passage 210k from one side of the holder 210 in the axial direction Dc. Thus, the inner peripheral surface 210f can satisfactorily guide the foreign matter in the hollow 210e of the holder 210 to the outlet 210h by gravity. Therefore, by using the outlet 210h of the holder 210, the foreign matter can be discharged to the outside of the holder 210 without providing the through hole of the holder 210. As a result, it is possible to improve the discharge ability to discharge foreign matter while ensuring the mechanical strength of the holder 210.

### Fifteenth Embodiment

In the above first embodiment, an example has been described in which the holder includes the reaction force generator 50 that is displaced in the axial direction.

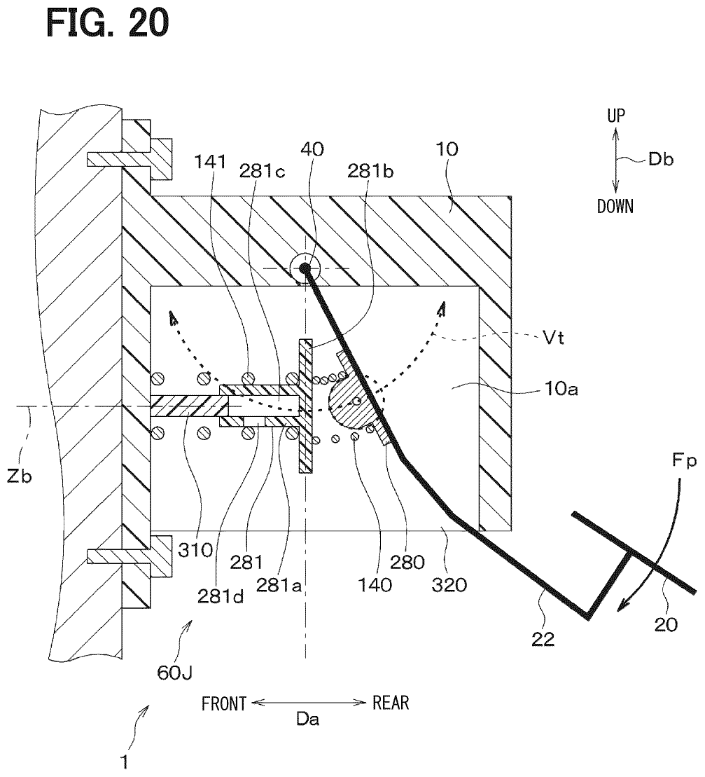

However, instead of this, a pedal device 1 of the present fifteenth embodiment that includes a reaction force generator 60J in which the holder is displaced in the circumferential direction will be described with reference to FIG. 20.

FIG. 20 is a cross-sectional view illustrating the overall configuration of the pedal device 1 of the present embodiment.

As illustrated in FIG. 20, the pedal device 1 of the present embodiment includes a pedal 20, a pedal arm 22, and the reaction force generator 60J.

The reaction force generator 60J includes a housing 10, elastic members 140, 141, and holders 280, 281.

The pedal 20 is supported by a pedal arm 22. The pedal arm 22 is configured to be displaceable relative to the housing 10 in a circumferential direction Vt around the rotation shaft 40.

As a result, the pedal 20 is configured to be displaceable in the circumferential direction Vt. The pedal arm 22 transmits the pedal force of the driver 81 applied to the pedal 20 to the holder 280.

The housing 10 includes an accommodation chamber 10a that accommodates the elastic members 140, 141 and the holders 280, 281. The housing 10 is provided with a lower opening 320 that opens to the vehicle lower side.

The holder 280 is configured to be displaceable in the circumferential direction Vt around the rotation shaft 40. The holder 281 is disposed on the front side of the vehicle relative to the holder 280. The holder 281 is configured to be displaceable in the vehicle travel direction Da by being guided by a guide portion 310.

The holder 281 includes a cylindrical portion 281a formed in a cylindrical shape around the axis Zb and a flange 281b protruding radially outward from the cylindrical portion 281a around the axis Zb. The guide portion 310 is inserted into a hollow 281c of the holder 281.

The guide portion 310 is supported by the housing 10 and is formed in an axial shape extending along the axis Zb.

The elastic member 140 is, for example, a coil spring formed in a spiral shape around the axis Zb. The axis Zb is an imaginary line extending in the vehicle travel direction Da. The elastic member 140 is a first elastic member that supports the holder 280 while being supported by the holder 280.

The elastic member 141 is, for example, a coil spring formed in a spiral shape around the axis Zb. The elastic member 141 is a first elastic member that supports the flange 281b of the holder 281 while being supported by the inner wall of the housing 10.

Each of the holders 281, 280 of the present embodiment is made of a metal material or a resin material.

Next, the operation of the pedal device 1 of the present embodiment will be described.

First, when the pedal force of the driver 81 is applied to the pedal 20, the pedal arm 22 is displaced to the front side of the vehicle, and the pedal force of the driver 81 is applied to the holder 280 through the pedal arm 22. Accordingly, the holder 280 rotates to one side in a rotation direction Vtk around the rotation shaft 40.

Accordingly, the holder 280 presses the elastic member 140 from the rear side of the vehicle. Thus, the elastic member 140 is compressed through elastic deformation while being supported by the holder 280.

As described above, the elastic member 140 is compressed through elastic deformation, whereby the elastic member 140 applies an elastic force to the holder 280. Hence, the elastic member 140 applies an elastic force to the pedal 20 via the holder 280 and the pedal arm 22 as a reaction force against the rotational force of the pedal 20.

At this time, the elastic force of the elastic member 140 is applied to the holder 281. Therefore, the holder 281 is guided by the guide portion 310 and displaced to the front side of the vehicle. Accordingly, in the holder 281, the flange 281b presses the elastic member 141 against the front side of the vehicle. As a result, the elastic member 141 is compressed through elastic deformation.

When the pedal 20 swings, changing its position from the non-depressed state to the fully depressed state, the elastic members 140, 141 are increasingly elastically deformed as the pedal 20 approaches the fully depressed state from the non-depressed state. For this reason, as the pedal 20 approaches the fully depressed state from the non-depressed state, the reaction force applied by the reaction force generator 60J to the pedal 20 increases.

Thereafter, when the pedal 20 is released from the foot of the driver 81 and the application of the pedal force of the driver 81 to the pedal 20 is stopped, the elastic deformation of the elastic members 140, 141 returns.

In this case, with the elastic force of the elastic member 140 applied to the link member 25, the holder 281 is guided by the guide portion 310 and displaced to the rear side of the vehicle. The holder 280 rotates to the other side in the rotation direction Vtk around the rotation shaft 40. The pedal 20 rotates together with the pedal arm 22 to the other side of the rotation direction Vtk.

At this time, foreign matter in the hollow 281c of the holder 281 is guided by gravity from a passage 281d to the vehicle lower side of the holder 281. The foreign matter is discharged by gravity from the lower opening 320 of the housing 10 to the vehicle lower side.

According to the present embodiment described above, the pedal device 1 includes the holder 280 that is displaced to one side in the circumferential direction Vt by the rotational force applied by the pedal 20 via the pedal arm 22 as the pedal 20 rotates.

The pedal device 1 includes the elastic member 140 that is compressed through elastic deformation due to displacement of the holder 280 while supporting the holder 280, and the elastic member 141 that is supported by the inner wall of the housing 10 and supports the holder 280.

The holder 280 is configured to be displaceable in the circumferential direction Vt around the rotation shaft 40. The holder 281 receives the elastic force of the elastic member 140 to be guided by the guide portion 310 and displaced in the vehicle travel direction Da.

The holder 281 is provided with a passage 281d that guides foreign matter such as dust and water from the inside of the hollow 281c to the vehicle lower side of the holder 281 by gravity.

Therefore, since the foreign matter can be discharged to the outside of the hollow 281c of the holder 281, it is possible to provide the pedal device 1 capable of preventing a malfunction of the holder 281 caused by foreign matter such as water.

### Sixteenth Embodiment

In the present sixteenth embodiment, a specific example of the passage 13a of the elastic member 70A according to the above fifth embodiment will be described with reference to FIG. 21. FIG. 21 is a view corresponding to a cross section taken along line XXI-XXI in FIG. 8.

As illustrated in FIG. 21, the elastic member 70A is provided with a projection 71 that projects toward a housing 10. Two passages 13a are provided on the vehicle upper side and the vehicle lower side of the projection 71 in the elastic member 70A. That is, the two passages 13a are formed of the elastic member 70A. Each of the two passages 13a is formed to be recessed toward a center Ta of the elastic member 70A.

### Seventeenth Embodiment

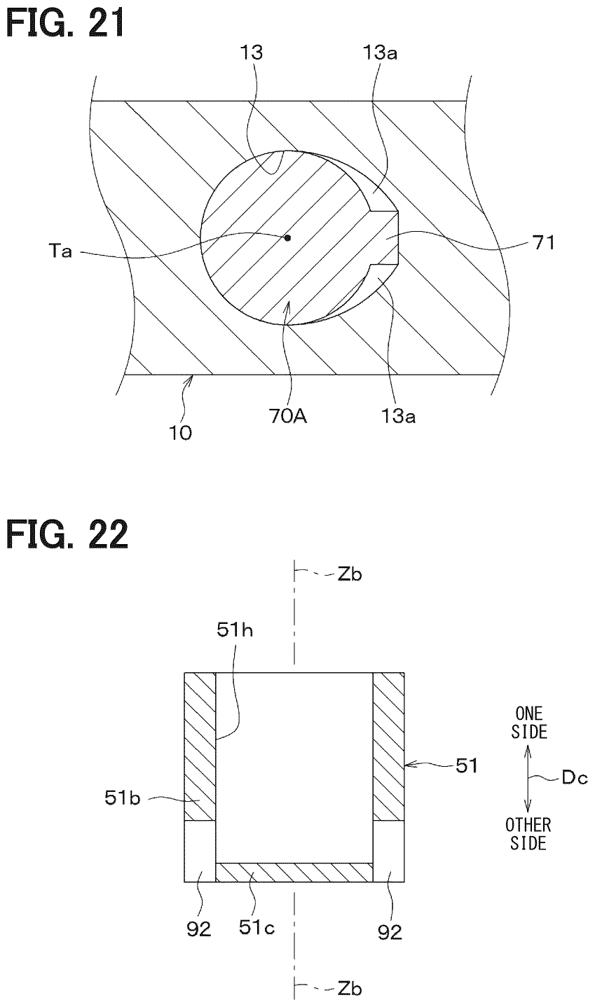

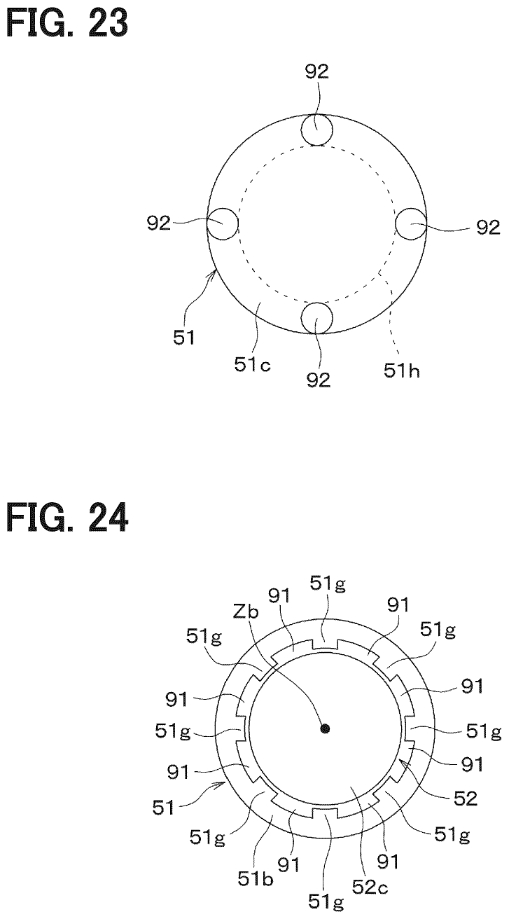

In the above first embodiment, an example in which the passage 90 is provided at the bottom 51c of the holder 51 has been described. However, instead of this, the present seventeenth embodiment will be described with reference to FIGS. 22, 23, in which a plurality of passages 90 formed across the bottom 51c and the cylindrical portion 51b of the holder 51 are provided.

FIG. 22 is a cross-sectional view illustrating a single holder 51 of the present embodiment, and FIG. 23 is a view of the single holder 51 in FIG. 22 from the other side in the axial direction Dc.

As illustrated in FIGS. 22, 23, each of the plurality of passages 92 of the present embodiment is formed over the bottom 51c and the cylindrical portion 51b of the holder 51.

### Eighteenth Embodiment

In the above first embodiment, an example in which the holder 51 is provided with one passage 91 has been described. However, instead of this, the present eighteenth embodiment in which a plurality of passages 91 are provided in the holder 51 will be described with reference to FIG. 24.

FIG. 24 is a view of the holders 51, 52 of the present embodiment as seen from one side in the axial direction Dc, and illustrates a specific example in which eight passages 91 are provided in the holder 51.

As illustrated in FIG. 24, the plurality of passages 91 of the present embodiment are arranged in the circumferential direction around the axis Zb. Each of the plurality of passages 91 is formed to be recessed radially outward around the axis Zb in the holder 51. The plurality of passages 91 are covered from the radially inner side around the axis Zb by the outer peripheral surface of the holder 52.

The holder 51 is provided with a plurality of partitions 51g that are disposed between two adjacent passages 91 among the plurality of passages 91. Each of the plurality of partitions 51g is provided to partition two adjacent passages 91 among the plurality of passages 91.

### Nineteenth Embodiment

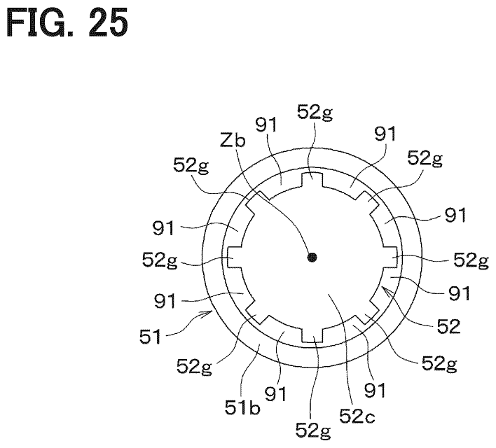

In the above first embodiment, an example in which the holder 51 is provided with one passage 91 has been described. However, instead of this, the present nineteenth embodiment in which a plurality of passages 91 are provided in the holder 52 will be described with reference to FIG. 25.

FIG. 25 is a view of the holders 51, 52 of the present embodiment as seen from one side in the axial direction Dc, and illustrates a specific example in which eight passages 91 are provided in the holder 51.

As illustrated in FIG. 25, each of the plurality of passages 91 is arranged in the circumferential direction around the axis Zb. Each of the plurality of passages 91 is formed to be recessed radially inward from the outer peripheral surface of the holder 52 around the axis Zb. Each of the plurality of passages 91 is covered from the radially outer side by an inner peripheral surface of the holder 51 around the axis Zb.

The holder 52 is provided with a plurality of partitions 52g that are disposed between two adjacent passages 91 among the plurality of passages 91. Each of the plurality of partitions 52g is provided to partition two adjacent passages 91 among the plurality of passages 91.

### Twentieth Embodiment

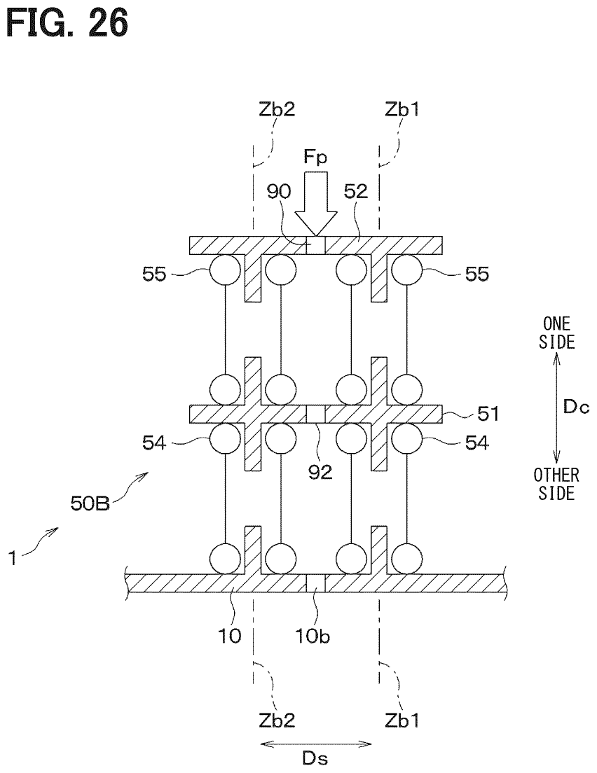

In the above first to fifth embodiments, the reaction force generator 50 in which one elastic member is disposed between the holders 51, 52 in the pedal device 1 has been described. However, instead of this, a reaction force generator 50B of the present twentieth embodiment in which two elastic members are arranged in parallel between the holders 51, 52 in the pedal device 1 will be described with reference to FIG. 26.

FIG. 26 is a cross-sectional view illustrating an arrangement relationship of the holders 51, 52, two elastic members 55, and two elastic members 54 in the reaction force generator 50B in the pedal device 1 of the present embodiment.

As illustrated in FIG. 26, in the reaction force generator 50B, the holder 52 is disposed on one side in the axial direction Dc relative to the holder 51. The holder 51 is disposed on one side in the axial direction Dc relative to the bottom of a housing 10.

The holders 52, 51 are each disclosed to be displaceable in the axial direction Dc. The holder 51 constitutes a support member that supports the two elastic members 55 from the other side in the axial direction Dc. In the present embodiment, the holder 52 is disposed on the vehicle upper side relative to the holder 51.

Similarly to the housing 10 of the above first embodiment, the housing 10 of the present embodiment accommodates the holders 51, 52, the two elastic members 55, and the two elastic members 54.

The two elastic members 55 are arranged in parallel between the holders 51, 52 of the present embodiment. Between the bottom surfaces of the holder 51 and the housing 10, the two elastic members 55 are arranged in parallel.

Here, of the two elastic members 55, the elastic member 55 on the right side of the drawing is, for example, a coil spring formed in a spiral shape around the axis Zb1. Of the two elastic members 55, the elastic member 55 on the left side of the drawing is, for example, a coil spring formed in a spiral shape around the axis Zb2.

Each of the two elastic members 55 supports the holder 51 from the other side in the axial direction Dc while being supported by the holder 52. Each of the two elastic members 54 supports the holder 51 from the other side in the axial direction Dc while being supported by the bottom of the housing 10.

Of the two elastic members 54, the elastic member 54 on the right side of the drawing is, for example, a coil spring formed in a spiral shape around the axis Zb1. Of the two elastic members 54, the elastic member 54 on the right side of the drawing is, for example, a coil spring formed in a spiral shape around the axis Zb2.

The holder 51 of the present embodiment is provided with a passage 92 that allows foreign matter to pass by gravity, vibration, or the like. The holder 52 is provided with a passage 90 that allows foreign matter to pass by gravity, vibration, or the like. The bottom of the housing 10 constitutes a support member that supports the two elastic members 54 from the other side in the axial direction Dc. The bottom of the housing 10 is provided with a passage 10b that allows foreign matter to pass by gravity or the like.

Here, with the pedal device 1 installed in the vehicle 80, the elastic members 54, 55 are arranged such that the axes Zb1, Zb2 are orthogonal to or inclined relative to the horizontal direction Ds.

Next, the operation of the pedal device 1 of the present embodiment will be described.

First, when the pedal force of the driver 81 is applied to the pedal 20, the pedal 20 rotates and applies a rotational force Fp to the holder 52. Accordingly, the holder 52 is displaced to the other side in the axial direction Dc. Thus, the holder 52 is pressed from one side in the axial direction Dc by the rotational force Fp from the pedal 20 and is displaced to the other side in the axial direction Dc.

Therefore, the two elastic members 55 are pressed by the holder 51 from one side in the axial direction Dc while being supported by the holder 52, to be compressed through elastic deformation.

At this time, the two elastic members 55 apply elastic forces to the pedal 20 through the holder 52 as reaction forces against the rotational force Fp from the pedal 20.

Furthermore, the elastic forces of the two elastic members 55 are applied to the holder 52 from one side in the axial direction Dc. Thus, the holder 52 is displaced to the other side in the axial direction Dc due to the elastic force of the two elastic members 55.

In this case, the two elastic members 54 are pressed by the holder 51 from one side in the axial direction Dc while being supported by the bottom of the housing 10, to be compressed through elastic deformation. Accordingly, each of the two elastic members 54 applies an elastic force to the holder 51 as a reaction force against the force pressed from the holder 51.

In this manner, the two elastic members 55 and the two elastic members 54 are compressed through elastic deformation to apply elastic forces to the pedal 20 via the holders 51, 52 as reaction forces against the rotational force of the pedal 20.

When the pedal 20 swings, changing its position from the non-depressed state to the fully depressed state, the two elastic members 55 and the two elastic members 54 are increasingly elastically deformed as the pedal 20 approaches the fully depressed state from the non-depressed state. For this reason, as the pedal 20 approaches the fully depressed state from the non-depressed state, the reaction force applied by the reaction force generator 50B to the pedal 20 increases.

Thereafter, when the pedal 20 is released from the foot of the driver 81 and the application of the pedal force of the driver 81 to the pedal 20 is stopped, the elastic deformation of the two elastic members 55 and the elastic deformation of the two elastic members 54 returns.

In this case, with the elastic forces of the two elastic members 55 and the two elastic members 54 applied to the pedal 20, the pedal 20 swings.

At this time, foreign matter such as water on the vehicle upper side of the holder 52 is guided by gravity to the vehicle lower side of the holder 52 through the passage 90. Foreign matter such as water on the vehicle upper side of the holder 51 is guided by gravity to the bottom of the housing 10 through the passage 92.

The foreign matter guided to the bottom of the housing 10 is guided by gravity to the vehicle lower side of the housing 10 through the passage 10b.

According to the present embodiment described above, in the reaction force generator 50B in the pedal device 1, the two elastic members 55 support the holder 51 from the other side in the axial direction Dc while being supported by the holder 52. Each of the two elastic members 55 receives the rotational force Fp applied by the pedal 20 from one side in the axial direction Dc via the holder 52 to elastically deform and apply an elastic force to the holder 52.

Therefore, the reaction force generator 50B of the present embodiment can apply a large reaction force to the pedal 20 relative to the rotational force Fp applied by the pedal 20, compared to the case of using one elastic member 55.

Furthermore, in the reaction force generator 50B in the pedal device 1 of the present embodiment, each of the two elastic members 54 supports the holder 51 from the other side in the axial direction Dc while being supported by the bottom of the housing 10. Each of the two elastic members 54 receives the rotational force Fp applied by the pedal 20 from one side in the axial direction Dc via the holder 52, the two elastic members 55, and the holder 51 to elastically deform and apply an elastic force to the holder 51.

Therefore, the reaction force generator 50B of the present embodiment can apply a large reaction force to the pedal 20 relative to the rotational force Fp applied by the pedal 20, compared to the case of using one elastic member 54.

Furthermore, the foreign matter can be discharged from the upper side of the holder 51 to the lower side of the holder 51 through the passage 92. The foreign matter can be discharged from the upper side of the holder 52 to the lower side of the holder 52 through the passage 90. This can prevent malfunctions of the holders 51, 52 and the elastic members 55, 54 caused by foreign matter.

### First Modification of Twentieth Embodiment

In the above twentieth embodiment, an example in which the two elastic members 55 are arranged in parallel in the pedal device 1 has been described, but instead of this, three or more elastic members 55 may be arranged in parallel.

Furthermore, in the above twentieth embodiment, the pedal device 1 is not limited to the case where the two elastic members 54 are arranged in parallel, and three or more elastic members 54 may be arranged in parallel.

### Second Modification of Twentieth Embodiment

Similarly to the case of the twentieth embodiment, the above first to fourth embodiments are not limited to the arrangement of one elastic member 55 between the pedal 20 and the holder 52, and a plurality of elastic members 55 may be disposed in parallel between the pedal 20 and the holder 52.

Similarly, the above first to fourth embodiments are not limited to the arrangement of one elastic member 54 between the holders 51, 52, and a plurality of elastic members 54 may be disposed in parallel between the holders 51, 52.

Similarly, the above first to fourth embodiments are not limited to the arrangement of one elastic member 53 between the holder 51 and the housing 10, and a plurality of elastic members 53 may be disposed in parallel between the holder 51 and the housing 10.

### Twenty-first Embodiment

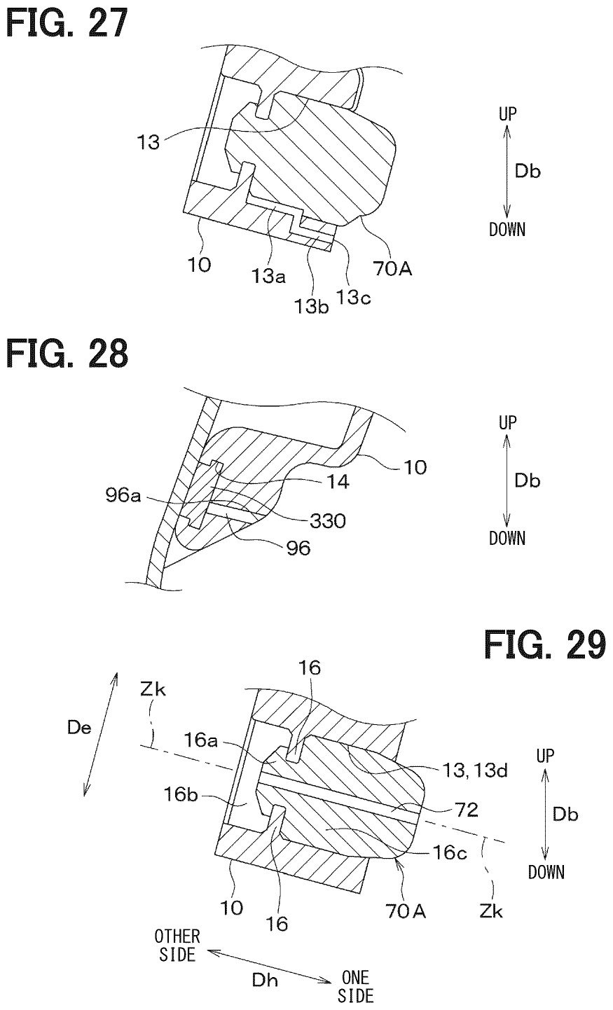

In the fifth embodiment, an example in which the elastic member 70A is provided with the passage 13a to guide foreign matter in the accommodation chamber 13 to the outside of the accommodation chamber 13 by gravity has been described. However, in addition to this, the present twenty-first embodiment in which the passage 13a is formed to extend toward the vehicle lower side as the passage 13a approaches an outlet 13c will be described with reference to FIG. 27.

FIG. 27 is a cross-sectional view illustrating the elastic member 70A, the accommodation chamber 13, and the passages 13a, 13b of the present embodiment, and corresponds to an enlarged view of the elastic member 70A and its periphery in the above fifth embodiment of FIG. 8.

As illustrated in FIG. 27, in the present embodiment, passages 13a, 13b for guiding foreign matter in the accommodation chamber 13 of a housing 10 to the outside of the accommodation chamber 13 by gravity are provided. The passage 13a is formed to be recessed inward from the outer surface of the elastic member 70A. The passage 13a is covered from the vehicle lower side by the inner wall of the housing 10.

The passage 13b is a passage for guiding the foreign matter having passed through the passage 13a to the outside of the housing 10 (i.e., the accommodation chamber 13). The passage 13b is provided in the housing 10. The passage 13b is formed to communicate with the passage 13a and guide the foreign matter to the outlet 13c. The outlet 13c is open to the outside of the housing 10.

The passage 13a of the present embodiment is formed to extend toward the vehicle lower side as approaching the outlet 13c. The passage 13b is formed to extend toward the vehicle lower side as approaching the outlet 13c.

According to the present embodiment described above, each of the passages 13a, 13b is formed to extend toward the vehicle lower side as approaching the outlet 13c. Therefore, the discharge ability to discharge foreign matter in the accommodation chamber 13 to the outside of the accommodation chamber 13 can be improved.

### Twenty-second Embodiment

In the above twenty-first embodiment, an example in which the passages 13a, 13b are formed to extend toward the vehicle lower side as approaching the outlet 13c has been described. Similarly, the present twenty-second embodiment will be described with reference to FIG. 28, in which a passage 96 for guiding foreign matter in the accommodation chamber 14 to the outside of the accommodation chamber 14, as in the above fifth embodiment, is formed to extend toward the vehicle lower side as the passage 96 approaches an outlet 96a.

FIG. 28 is a cross-sectional view illustrating the elastic member 330, the accommodation chamber 14, and the passage 96 of the present embodiment, and corresponds to an enlarged view of the elastic member 330 and its periphery in the above fifth embodiment of FIG. 8.

As illustrated in FIG. 28, in the present embodiment, a housing 10 is provided with a passage 96 to guide foreign matter in the accommodation chamber 14 for holding the elastic member 330 to the outside of the accommodation chamber 14. The passage 96 is provided with the outlet 96a that guides foreign matter to the outside of the housing 10. The passage 96 of the present embodiment is formed to extend toward the vehicle lower side as approaching the outlet 96a.

According to the present embodiment described above, each of the passages 96 is formed to extend toward the vehicle lower side as approaching the outlet 96a. Therefore, the discharge ability to discharge foreign matter in the accommodation chamber 14 to the outside of the accommodation chamber 14 can be improved.

### Twenty-third Embodiment

In the above twenty-first embodiment, an example has been described in which a passage formed to be recessed inward from the outer surface of the elastic member 70A is provided as the passage 13a for guiding foreign matter in the accommodation chamber 13 to the outside of the accommodation chamber 13.

However, a pedal device 1 of the present twenty-third embodiment will be described with reference to FIG. 29, in which a through hole penetrating the elastic member 70A is a passage 72 that allows foreign matter to pass.

FIG. 29 is a cross-sectional view illustrating the elastic member 70A, the accommodation chamber 13, and the passage 72 of the pedal device 1 of the present embodiment, and corresponds to an enlarged view of the elastic member 70A and its periphery in the above fifth embodiment of FIG. 8.

As illustrated in FIG. 29, in the present embodiment, the passage 72 is formed to penetrate the elastic member 70A in an axial direction Dh. The passage 72 is provided to guide foreign matter from the accommodation chamber 13 that accommodates the elastic member 70A to the outside of the accommodation chamber 13.

The elastic member 70A of the present embodiment is formed of an elastic member such as rubber, has a substantially cylindrical shape around an axis Zk, and is formed to be projected toward one side in the axial direction Dh. The axial direction Dh is a direction in which the axis Zk extends. The elastic member 70A is elastically deformed by a force applied by the pedal to one side in the axial direction Dh, and applies the elastic force to the pedal as a reaction force against the force from the pedal.

In a housing 10 of the present embodiment, a protrusion 16 protruding from an inner wall 13d toward the axis Zk is provided on the inner wall 13d forming the accommodation chamber 13. The protrusion 16 is formed over the circumferential direction around the axis Zk. The protrusion 16 serves to reduce the cross-sectional area of the accommodation chamber 13.

A direction orthogonal to the axial direction Dh is defined as an orthogonal direction De. The cross-sectional area of the accommodation chamber 13 is an area of a cross section of the accommodation chamber 13 taken along a cross section including the orthogonal direction De. A region 16a of the accommodation chamber 13 that is sandwiched by the protrusion 16 has a smaller cross-sectional area in the orthogonal direction De than regions 16b, 16c of the accommodation chamber 13 other than region 16a.

The region 16b is disposed on the other side in the axial direction Dh relative to the protrusion 16 (i.e., the region 16a) in the accommodation chamber 13. The region 16c is disposed on one side in the axial direction Dh relative to protrusion 16 (i.e., the region 16a) in the accommodation chamber 13.

Therefore, the elastic member 70A is accommodated in the accommodation chamber 13 in a compressed state through elastic deformation by being press-fitted by the protrusion 16. That is, the elastic member 70A is supported by the protrusion 16 of the housing 10 while being accommodated in the accommodation chamber 13.

The axial direction Dh of the present embodiment is a direction inclined in the vehicle vertical direction Db. One side of the elastic member 70A in the axial direction Dh is positioned on the vehicle lower side relative to the other side of the elastic member 70A in the axial direction Dh. One side of the passage 72 in the axial direction Dh is positioned on the vehicle lower side relative to the other side of the passage 72 in the axial direction Dh.

Thus, the foreign matter in the region 16b on the other side of the accommodation chamber 13 in the axial direction Dh is guided by gravity to one side (i.e., the outside of the accommodation chamber 13) in the axial direction Dh relative to the accommodation chamber 13 through the passage 72.

According to the present embodiment described above, the pedal device 1 includes the pedal 20 and the elastic member 70A that elastically deforms by the force, applied by the pedal 20 as the pedal 20 is displaced, to apply an elastic force to the pedal 20 as a reaction force against the force. The pedal device 1 includes the housing 10 that forms an accommodation chamber 13 in which the elastic member 70A is accommodated. The elastic member 70A is supported by the housing 10 while being press-fitted into the accommodation chamber 13. The elastic member 70A is provided with a passage 72 that is formed to penetrate the elastic member 70A and allows foreign matter to pass. Therefore, the foreign matter is discharged by gravity from the region 16b of the accommodation chamber 13 through the passage 72.

Therefore, it is possible to prevent foreign matter from accumulating in the region 16b of the accommodation chamber 13. For this reason, the housing 10 and the elastic member 70A are not hydrolyzed by foreign matter such as water. This can prevent malfunctions of the housing 10 and the elastic member 70A caused by foreign matter.

### OTHER EMBODIMENTS

(1) In the above first to twenty-third embodiments, an example in which the brake device is applied to the brake-by-wire system 82 has been described.

However, instead of this, the brake device may be applied to a brake system in which a brake pedal and a brake pad are connected by a mechanical means, such as a cable or a hydraulic pressure, to transmit the operation force of the driver to the brake pad.

(2) In the above first to fifth embodiments, an example in which the reaction force generator 50 is formed of the elastic members 55, 54, 53 and the holders 51, 52 has been described. However, the present invention is not limited thereto, and the following may be performed.

The elastic member 55 and the holder 51 may be removed, and the elastic members 54, 53 and the holder 52 may constitute the reaction force generator 50. In this case, the elastic member 54 is subjected to a rotational force from the pedal 20.

Alternatively, the elastic member 53 and the holder 51 may be removed, and the elastic members 55, 54 and the holder 52 may constitute the reaction force generator 50. In this case, the elastic member 54 is supported by the bottom of the housing 10.

(3) In the above first to fifth embodiments, an example in which the elastic members 55, 54, 53 are coil springs has been described, but the present invention is not limited thereto, and various springs other than coil springs may be used as the elastic members 55, 54, 53.

(4) In the above sixth and eighth embodiments, an example in which the elastic members 140, 141, 142 are coil springs has been described, but the present invention is not limited thereto, and various springs other than coil springs may be used as the elastic members 140, 141, 142.

(5) In the above seventh embodiment, an example in which the elastic member 140 is a leaf spring has been described, but the present invention is not limited thereto, and various springs other than a leaf spring may be used as the elastic member 140.

(6) In the above ninth embodiment, an example in which the elastic members 180, 181, 182, 183, 184 are leaf springs has been described, but the present invention is not limited thereto, and various springs other than leaf springs may be used as the elastic members 180, 181, 182, 183, 184.

(7) In the above tenth and eleventh embodiments, an example in which the elastic member 140 is a leaf spring has been described, but the invention is not limited thereto, and various springs other than a leaf spring may be used as the elastic member 140.

(8) In the above twelfth embodiment, an example in which the elastic members 186, 187 are leaf springs has been described, but the present invention is not limited thereto, and various springs other than leaf springs may be used as the elastic members 186, 187.

(9) In the above thirteenth embodiment, an example in which the elastic members 230, 231 are coil springs has been described, but the present invention is not limited thereto, and various springs other than coil springs may be used as the elastic members 186, 187.

(10) In the above fourteenth embodiment, an example in which the elastic members 230, 231, 232 are coil springs has been described, but the present invention is not limited thereto, and various springs other than coil springs may be used as the elastic members 230, 231, 232.

(11) In the above fifteenth embodiment, an example in which the elastic members 140, 141 are coil springs has been described, but the present invention is not limited thereto, and various springs other than coil springs may be used as the elastic members 140, 141.

(12) In the above first to fifth embodiments, an example in which two holders 51, 52 are used as the reaction force generator 50 has been described, but the present invention is not limited thereto, and the number of holders used for the reaction force generator 50 may be one or three or more.

(13) In the above first to fifteenth embodiments, an example in which the pedal device 1 is applied to the brake pedal device has been described. However, instead of this, the pedal device 1 may be applied to an accelerator pedal device. Alternatively, the pedal device 1 may be applied to a clutch pedal device.

(14) In the above first to fifteenth embodiments, an example in which the pedal device 1 is applied to the vehicle 80 has been described, but instead of this, the pedal device 1 may be applied to various types of equipment other than the vehicle 80.

(15) In the above first to twenty-third embodiments, an example in which a member that is depressed by the driver 81 to be displaced is the pedal 20 has been described. However, the present invention is not limited thereto, and a member operated by the fingers, hand, or other parts of the operator may be used as the pedal 20. Alternatively, a member that is operated by being kicked up by the operator may be used as the pedal 20.

(16) In the above first to fourth embodiments, an example in which the bottom 51c of the holder 51 is a support that supports the elastic member 54 has been described. However, instead of this, a lid that closes the cylindrical portion 51b of the holder 51 from one side in the axial direction Dc may be used as a support that supports the elastic member 54.

(17) In the above first to fourth embodiments, an example in which the plurality of passages 92 are provided at the bottom 51c of the holder 51 (i.e., the support) has been described, but instead of this, the plurality of passages 92 may be provided at the bottom of the holder 52.

Here, the plurality of passages 92 may be provided in the lid that closes the cylindrical portion 52b of the holder 52 from one side in the axial direction Dc.

(18) In the above first to fourth embodiments, an example in which the plurality of ribs 92a are provided on the bottom 51c of the holder 51 has been described, but instead of this, the plurality of ribs 92a may be provided on the bottom of the holder 52.

Here, a plurality of ribs 92a may be provided on a lid that closes the cylindrical portion 52b of the holder 52 from one side in the axial direction Dc.

(19) In the above third and fourth embodiments, an example in which the bottom surface 51f of the bottom 51c of the holder 51 is formed in an inclined shape has been described, but instead of this, the bottom surface 51f of the bottom 51c of the holder 51 may be formed in an inclined shape.

Here, the plurality of passages 92 may be formed in the lid that closes the cylindrical portion 52b of the holder 52 from one side in the axial direction Dc, and the surface of the lid formed on one side in the axial direction Dc may be formed in an inclined shape.

(20) In the above fifth embodiment, an example in which the housing 10 is provided with the passage 96 that guides foreign matter in the accommodation chamber 14 to the outside of the accommodation chamber 14 has been described. However, instead of this, the housing 10 in each of the above first to fourth embodiment may be provided with a passage 96 that guides foreign matter in the accommodation chamber 14 to the outside of the accommodation chamber 14.

(21) In the above fifth embodiment, an example in which the elastic member 70A is provided with the passage 13a that guides foreign matter in the accommodation chamber 13 to the outside of the accommodation chamber 13 by gravity has been described. However, instead of this, in the elastic member 70A in each of the above first to fourth embodiments may be provided with a passage 13a that guides foreign matter in the accommodation chamber 13 to the outside of the accommodation chamber 13 by gravity.

(22) In the above fifth embodiment, an example has been described in which the passages 93, 94 are arranged on the vehicle lower side of the holder 52 relative to the reference plane Zh when the virtual plane of the holder 52 equidistant from the uppermost portion and the lowermost portion is defined as the reference plane Zh.

Similarly, in the reaction force generator 50B of the above twentieth embodiment, a passage disposed on the vehicle lower side of the holder 52 relative to the reference plane Zh may be provided.

Here, when the holder 52 is formed in a cylindrical shape, the passage disposed on the vehicle lower side of the holder 52 relative to the reference plane Zh may be a passage provided in a member that closes the cylindrical portion of the holder 52 from the axial direction Dc. The passage disposed on the vehicle lower side of the holder 52 relative to the reference plane Zh may be a passage provided in the cylindrical portion of the holder 52.

Furthermore, a passage disposed on the vehicle lower side of the holder 51 relative to the reference plane Zh may be provided.

Here, when the holder 51 is formed in a cylindrical shape, the passage disposed on the vehicle lower side of the holder 51 relative to the reference plane Zh may be a passage provided in a member that closes the cylindrical portion of the holder 51 from the axial direction Dc. The passage disposed on the vehicle lower side of the holder 51 relative to the reference plane Zh may be a passage provided in the cylindrical portion of the holder 51.

(23) In the above fifth embodiment, an example in which the passage 93A is provided at the position of the holder 52 that includes the reference plane Zh has been described.

Similarly, in the reaction force generator 50B of the above twentieth embodiment, a passage may be provided at a position of the holder 52 that includes the reference plane Zh. Alternatively, a passage may be provided at a position of the holder 51 that includes the reference plane Zh.

(24) In the above fifth embodiment, an example has been described in which the inner peripheral surface 400 of the cylindrical portion 52b of the holder 52 is formed to extend radially outward as approaching the outlet 401 in the axial direction Dc.

Similarly, in the reaction force generator 50B of the above twentieth embodiment, when the holder 52 is provided in a cylindrical shape, the inner peripheral surface 400 of the cylindrical portion 52b of the holder 52 may be formed to extend radially outward as approaching the outlet 401 in the axial direction Dc.

(25) In the above fifth embodiment, an example has been described in which the recess is provided on the inner peripheral surface of the holder 51 as the passage 91A that allows foreign matter to pass from the holders 51, 52.

However, instead of this, a gap formed between the inner peripheral surface of the holder 51 and the outer peripheral surface of the holder 52 may be used as a passage for allowing foreign matter to pass from the holders 51, 52 by gravity in a state where no recess is provided in each of the inner peripheral surface of the holder 51 and the outer peripheral surface of the holder 52.

That is, as in the above fifth embodiment, with the axial direction Dc inclined relative to the vehicle vertical direction Db, a gap formed between the holders 51, 52 may be used as a passage for allowing foreign matter to pass from the holders 51, 52 by gravity.

Here, the gap is a gap formed so that one of the inner peripheral surface of the holder 51 and the outer peripheral surface of the holder 52 slides relative to the other.

Furthermore, in the above first embodiment, the gap formed between the housing 10 and the elastic member 70 may be used as a passage that discharges foreign matter from the accommodation chamber 13 in a state where no recess is formed in each of the inner wall forming the accommodation chamber 13 and the elastic member 70 of the housing 10.

That is, with the elastic member 70 press-fitted into the accommodation chamber 13 in the housing 10, a gap formed between the housing 10 and the elastic member 70 may be used as a passage for discharging foreign matter from the accommodation chamber 13.

In addition, when the outer wall of the holder slides relative to the inner wall of the housing 10, a gap formed between the outer wall of the holder and the inner wall of the housing 10 may be used as a passage that allows foreign matter to pass from the holder.

(26) In the above twentieth embodiment, an example in which two elastic members 55 and two elastic members 54 are arranged in the axial direction Dc in the reaction force generator in the pedal device has been described.

However, instead of this, in the reaction force generator in the pedal device, only one step of elastic members arranged in parallel may be provided.

That is, in the reaction force generator in the pedal device, the two elastic members 55 may be removed and the two elastic members 54 may be employed. Alternatively, in the reaction force generator in the pedal device, the two elastic members 55 may be employed and the two elastic members 54 may be removed.

(27) In the above twentieth embodiment, an example in which the elastic members arranged in parallel are arranged in two stages in the axial direction Dc in the reaction force generator in the pedal device has been described. However, instead of this, in the reaction force generator in the pedal device, the elastic members arranged in parallel may be arranged in three or more stages in the axial direction Dc.

(28) The present disclosure is not limited to the above embodiments and can be changed appropriately. The above embodiments are not unrelated to each other and can be appropriately combined unless the combination is obviously impossible. It is understood that in each of the above embodiments, the elements constituting the embodiment are not necessarily essential except for a case where it is explicitly stated that the elements are particularly essential and a case where the elements are considered to be obviously essential in principle. In the above embodiments, when a numerical value such as the number, a numerical value, an amount, or a range of the constituent elements of the embodiment is mentioned, the numerical value is not limited to specific numerical values unless otherwise specified as being essential or obviously limited to the specific numerical values in principle. In each of the above embodiments, when the shapes, positional relationships, and the like of the constituent elements and the like are referred to, the shapes, positional relationships, and the like are not limited thereto unless otherwise specified or limited to specific shapes, positional relationships, and the like in principle.

### VARIOUS ASPECTS

Various aspects of the present disclosure will be described. The reference symbol in parentheses attached to each of configuration elements of each aspect indicates an example of correspondence between the configuration element and a specific component described in the embodiments described above.

### Aspect 1

A pedal device includes: a pedal (20, 20A); a holder (51, 52, 133, 154, 132A, 210, 200, 281) configured to be displaceable in a predetermined direction (Dc) by receiving, from one side in the predetermined direction (Dc), a force that is applied by the pedal associated with a displacement of the pedal; and at least one elastic member (54, 55, 143, 141, 230) configured to support the holder from the other side in the predetermined direction, and configured to receive the force applied by the pedal from the one side in the predetermined direction via the holder, to be elastically deformed and to apply an elastic force to the holder. In addition, the holder includes at least one passage (90, 93, 93A, 94, 154, 161, 162, 211a, 200d, 281d) that allows foreign matter to pass. In this case, because accumulation of foreign matter in the holder can be reduced, it is possible to provide a pedal device capable of preventing malfunctions of the holder and the elastic member caused by foreign matter.

### Aspect 2

In the pedal device according to Aspect 1, the at least one elastic member (54, 55) is made of a plurality of elastic members arranged in parallel to support the holder from the other side in the predetermined direction and to be supported from the other side in the predetermined direction by a support member (51, 10), and the plurality of elastic members are configured to receive the force applied by the pedal from the one side in the predetermined direction via the holder, to be elastically deformed and to apply an elastic force to the holder.

### Aspect 3

In the pedal device according to Aspect 1, the at least one elastic member is defined as at least one first elastic member (54). In this case, the pedal device further includes at least one second elastic member (55, 141, 140, 231) that is supported by the holder from the other side in the predetermined direction, and is configured to receive from the one side in the predetermined direction (Dc), a force applied by the pedal associated with the displacement of the pedal, to be elastically deformed and to apply an elastic force to the pedal. In addition, the at least one first elastic member receives the force applied by the pedal from the one side in the predetermined direction via the holder and the at least one second elastic member, to be elastically deformed and to apply an elastic force to the holder.

### Aspect 4

In the pedal device according to any one of Aspects 1 to 3, when a virtual plane that is equidistant from an uppermost portion and a lowermost portion of the holder is defined as a reference plane (Zh), the at least one passage (93, 94) is disposed below the reference plane in the holder.

### Aspect 5

In the pedal device according to any one of Aspects 1 to 3, when a virtual plane that is equidistant from an uppermost portion and a lowermost portion of the holder is defined as a reference plane (Zh), the at least one passage (93A) is disposed at a position of the holder, the position including the reference plane.

### Aspect 6

In the pedal device according to Aspect 4 or 5, the reference plane is a virtual plane equidistant from an uppermost portion and a lowermost portion of the holder in a state where the pedal, the holder and the at least one elastic member are installed in a vehicle (80).

### Aspect 7

In the pedal device according to any one of Aspects 1 to 6, the holder includes a cylindrical portion (52b) formed in a cylindrical shape around an axis (Zb) extending in the predetermined direction and a cover member (52f) that closes the cylindrical portion from the predetermined direction, and the at least one passage (93) is disposed in the cover member.

### Aspect 8

In the pedal device according to any one of Aspects 1 to 6, the holder includes a cylindrical portion (52b) formed in a cylindrical shape around an axis (Zb) extending in the predetermined direction, and the at least one passage (94) is disposed in the cylindrical portion.

### Aspect 9

In the pedal device according to any one of Aspects 1 to 8, the holder includes a cylindrical portion (51b) formed in a cylindrical shape around an axis (Zb) extending in the predetermined direction, the at least one passage (91A) is provided by an inner peripheral surface (400) of the cylindrical portion around an axis (Zb) extending in the predetermined direction, the at least one passage (91A) includes an outlet (401) that is open in the predetermined direction in the cylindrical portion and is configured to discharge the foreign matter, and the at least one passage is provided to extend radially outward around the axis (Zb) as the one passage approaches the outlet in the predetermined direction.

### Aspect 10

The pedal device according to Aspect 3, further includes: a second holder (51) that is configured to be displaceable in the predetermined direction and to support the second elastic member from the other side in the predetermined direction, when the holder (52) is defined as a first holder; and a third elastic member (53) configured to support the second holder from the other side in the predetermined direction, and to receive the elastic force of the second elastic member via the second holder to be elastically deformed. In this case, when the at least one passage is defined as at least one first passage (90), the second holder includes at least one second passage (92) that allows foreign matter to pass.

### Aspect 11

The pedal device according to any one of Aspects 1 to 10, further includes a housing (10) that includes an accommodation chamber (10a) in which the at least one elastic member and the holder are accommodated. When the at least one passage is defined as at least one first passage, the housing includes at least one second passage (10b, 153) that is configured to allow the foreign matter to pass from the accommodation chamber to an outside of the housing.

### Aspect 12

A pedal device includes: a pedal (20); a holder (51) configured to be displaceable in a predetermined direction (Dc) by receiving, from one side in the predetermined direction (Dc), a force that is applied by the pedal associated with a displacement of the pedal; and at least one elastic member (54) that is supported by the holder from the other side in the predetermined direction, and is configured to receive a force applied by the pedal from the one side in the predetermined direction, to be elastically deformed and to apply an elastic force to the holder. In this case, the holder includes a support (51c) that supports the elastic member from the other side in the predetermined direction, and the support includes at least one passage (92) that allows foreign matter to pass. In this case, because accumulation of foreign matter in the holder can be reduced, it is possible to provide a pedal device capable of preventing malfunctions of the holder and the elastic member caused by foreign matter.

### Aspect 13

In the pedal device according to Aspect 12, the at least one passage is made of a plurality of passages that are arranged in a circumferential direction around an axis (Zb) extending in the predetermined direction, to allow foreign matter to pass.

### Aspect 14

In the pedal device according to Aspect 12 or 13, the holder includes a plurality of ribs (92a) each of which is disposed between adjacent two of the plurality of passages and which are provided radially around an axis (Zb) extending in the predetermined direction to form the plurality of passages, respectively.

### Aspect 15

In the pedal device according to any one of Aspects 12 to 14, an inclined surface (51f) is provided on one side of the support in the predetermined direction, and the inclined surface has an inclined shape inclined toward the other side in the predetermined direction as the inclined surface approaches the at least one passage (92).

### Aspect 16

In the pedal device according to any one of Aspects 12 to 15, the holder includes a cylindrical portion (51b) formed in a cylindrical shape around an axis (Zb) extending in the predetermined direction, the support is formed to close the cylindrical portion from the predetermined direction, and the at least one passage is formed to extend over the cylindrical portion and the support.

### Aspect 17

A pedal device includes: a pedal (20); a holder (51) configured to be displaceable in a predetermined direction (Dc) by receiving, from one side in the predetermined direction (Dc), a force that is applied by the pedal associated with a displacement of the pedal; at least one elastic member (53) that supports the holder from the other side in the predetermined direction, and receives a force applied by the pedal from the one side in the predetermined direction via the holder to be elastically deformed and to apply an elastic force to the holder; and a guide portion (12) configured to guide the holder to be displaceable in the predetermined direction. The guide portion includes a passage (300) that allows foreign matter to pass. In this case, because accumulation of foreign matter in the holder or the elastic member can be reduced, it is possible to provide a pedal device capable of preventing malfunctions of the holder and the elastic member caused by foreign matter.

### Aspect 18

A pedal device includes: a pedal (20, 20A); an elastic member (53, 54, 55, 70, 90, 130, 140 to 146, 180 to 181, 186, 187) that is elastically deformed by a force applied by the pedal associated with a displacement of the pedal, to apply an elastic force to the pedal; and a housing (10) that forms an accommodation chamber (10a, 13, 14) in which the elastic member is accommodated. The housing includes at least one passage (10b, 11, 153, 13a) that allows foreign matter to pass from the accommodation chamber to an outside of the housing. In this case, it is possible to provide a pedal device capable of preventing malfunctions of the holder and the elastic member caused by foreign matter.

### Aspect 19

In the pedal device according to Aspect 18, the elastic member is a spring that expands and contracts with an elastic deformation in a predetermined direction (Dc) that is oblique to a horizontal direction (Ds) in a state where the pedal, the elastic member, and the housing are installed in a vehicle (80).

### Aspect 20

A pedal device includes: a pedal (20A); an elastic member (70A) that is elastically deformed by a force applied by the pedal associated with displacement of the pedal, to apply an elastic force to the pedal as a reaction force against the force; and a housing (10) that defines an accommodation chamber (13) in which the elastic member is accommodated. The elastic member is supported by the housing while being accommodated in the accommodation chamber and includes at least one passage (13a) that allows foreign matter to pass from an inside of the accommodation chamber to an outside of the accommodation chamber. In this case, it is possible to provide a pedal device capable of preventing malfunctions of the elastic member caused by foreign matter.

### Aspect 21

In the pedal device according to Aspect 20, the at least one passage is made to discharge the foreign matter from an outlet (13c) to the outside of the accommodation chamber; and the at least one passage is provided to extend downward toward the outlet in a state where the pedal, the elastic member, and the housing are installed in a vehicle (80).

### Aspect 22

A pedal device includes: a pedal (20A); an elastic member (330) that is elastically deformed by a force applied by the pedal associated with a displacement of the pedal, to apply an elastic force to the pedal; and a housing (10) that defines an accommodation chamber (14) in which the elastic member is accommodated. The elastic member is supported by the housing while being accommodated in the accommodation chamber, and the housing includes at least one passage (96) that allows foreign matter to pass from an inside of the accommodation chamber to an outside of the accommodation chamber. In this case, it is possible to provide a pedal device capable of preventing malfunctions of the elastic member caused by foreign matter.

### Aspect 23

In the pedal device according to Aspect 22, the at least one passage includes an outlet (96a) that discharges the foreign matter, and the at least one passage is provided to extend downward as approaching the outlet in a state where the pedal, the elastic member, and the housing are installed in a vehicle (80).

### Aspect 24

A pedal device includes: a pedal (20); an elastic member (70A) that is elastically deformed by a force applied by the pedal associated with displacement of the pedal, to apply an elastic force to the pedal as a reaction force against the force; and a housing (10) that defines an accommodation chamber (13) in which the elastic member is accommodated. The elastic member is supported by the housing while being accommodated in the accommodation chamber, and the elastic member is provided with at least one passage (72) that is provided to penetrate the elastic member and to allow foreign matter to pass. In this case, it is possible to provide a pedal device capable of preventing malfunctions of the elastic member caused by foreign matter.

What is claimed is:

1. A pedal device comprising:
a pedal;
a holder configured to be displaceable in a predetermined direction by receiving, from one side in the predetermined direction, a force that is applied by the pedal associated with a displacement of the pedal; and
at least one elastic member configured to support the holder from the other side in the predetermined direction, and configured to receive the force applied by the pedal from the one side in the predetermined direction via the holder, to be elastically deformed and to apply an elastic force to the holder,
wherein the holder includes at least one passage that allows foreign matter to pass.

2. The pedal device according to claim 1, wherein
the at least one elastic member is made of a plurality of elastic members arranged in parallel to support the holder from the other side in the predetermined direction and to be supported from the other side in the predetermined direction by a support member, and
the plurality of elastic members are configured to receive the force applied by the pedal from the one side in the predetermined direction via the holder, to be elastically deformed and to apply an elastic force to the holder.

3. The pedal device according to claim 1, wherein the at least one elastic member is defined as at least one first elastic member, the pedal device further comprising
at least one second elastic member that is supported by the holder from the other side in the predetermined direction, and is configured to receive from the one side in the predetermined direction, a force applied by the pedal associated with the displacement of the pedal, to be elastically deformed and to apply an elastic force to the pedal,
wherein the at least one first elastic member receives the force applied by the pedal from the one side in the predetermined direction via the holder and the at least one second elastic member, to be elastically deformed and to apply an elastic force to the holder.

4. The pedal device according to claim 1, wherein
when a virtual plane that is equidistant from an uppermost portion and a lowermost portion of the holder is defined as a reference plane, the at least one passage is disposed below the reference plane in the holder.

5. The pedal device according to claim 1, wherein when a virtual plane that is equidistant from an uppermost portion and a lowermost portion of the holder is defined as a reference plane, the at least one passage is disposed at a position of the holder, the position including the reference plane.

6. The pedal device according to claim 4, wherein the reference plane is a virtual plane equidistant from an uppermost portion and a lowermost portion of the holder in a state where the pedal, the holder and the at least one elastic member are installed in a vehicle.

7. The pedal device according to claim 1, wherein
the holder includes a cylindrical portion formed in a cylindrical shape around an axis extending in the predetermined direction, and a cover member that closes the cylindrical portion from the predetermined direction, and
the at least one passage is disposed in the cover member.

8. The pedal device according to claim 1, wherein
the holder includes a cylindrical portion formed in a cylindrical shape around an axis extending in the predetermined direction, and
the at least one passage is disposed in the cylindrical portion.

9. The pedal device according to claim 1, wherein
the holder includes a cylindrical portion formed in a cylindrical shape around an axis extending in the predetermined direction,
the at least one passage is provided by an inner peripheral surface of the cylindrical portion around an axis extending in the predetermined direction,
the at least one passage includes an outlet that is open in the predetermined direction in the cylindrical portion and is configured to discharge the foreign matter, and
the at least one passage is provided to extend radially outward around the axis as the one passage approaches the outlet in the predetermined direction.

10. The pedal device according to claim 3, further comprising:
a second holder that is configured to be displaceable in the predetermined direction and to support the second elastic member from the other side in the predetermined direction, when the holder is defined as a first holder; and
a third elastic member configured to support the second holder from the other side in the predetermined direction, and to receive the elastic force of the second elastic member via the second holder to be elastically deformed,
wherein when the at least one passage is defined as at least one first passage, the second holder includes at least one second passage that allows foreign matter to pass.

11. The pedal device according to claim 1, further comprising
a housing that includes an accommodation chamber in which the at least one elastic member and the holder are accommodated,
wherein when the at least one passage is defined as at least one first passage, the housing includes at least one second passage that is configured to allow the foreign matter to pass from the accommodation chamber to an outside of the housing.

12. A pedal device comprising:
a pedal;
a holder configured to be displaceable in a predetermined direction by receiving, from one side in the predetermined direction, a force that is applied by the pedal associated with a displacement of the pedal; and
at least one elastic member that is supported by the holder from the other side in the predetermined direction, and is configured to receive a force applied by the pedal from the one side in the predetermined direction, to be elastically deformed and to apply an elastic force to the holder, wherein
the holder includes a support that supports the elastic member from the other side in the predetermined direction, and
the support includes at least one passage that allows foreign matter to pass.

13. The pedal device according to claim 12, wherein the at least one passage is made of a plurality of passages that are arranged in a circumferential direction around an axis extending in the predetermined direction, to allow foreign matter to pass.

14. The pedal device according to claim 13, wherein the holder includes a plurality of ribs each of which is disposed between adjacent two of the plurality of passages and which are provided radially around an axis extending in the predetermined direction to form the plurality of passages, respectively.

15. The pedal device according to claim 12, wherein
an inclined surface is provided on one side of the support in the predetermined direction, and the inclined surface has an inclined shape inclined toward the other side in the predetermined direction as the inclined surface approaches the at least one passage.

16. The pedal device according to claim 12, wherein
the holder includes a cylindrical portion formed in a cylindrical shape around an axis extending in the predetermined direction,
the support is formed to close the cylindrical portion from the predetermined direction, and
the at least one passage is formed to extend over the cylindrical portion and the support.

17. A pedal device comprising:
a pedal;
a holder configured to be displaceable in a predetermined direction by receiving, from one side in the predetermined direction, a force that is applied by the pedal associated with a displacement of the pedal;
at least one elastic member that supports the holder from the other side in the predetermined direction, and receives a force applied by the pedal from the one side in the predetermined direction via the holder to be elastically deformed and to apply an elastic force to the holder; and
a guide portion configured to guide the holder to be displaceable in the predetermined direction,
wherein the guide portion includes a passage that allows foreign matter to pass.

18. A pedal device comprising:
a pedal;
an elastic member that is elastically deformed by a force applied by the pedal associated with a displacement of the pedal, to apply an elastic force to the pedal; and
a housing that forms an accommodation chamber in which the elastic member is accommodated,
wherein the housing includes at least one passage that allows foreign matter to pass from the accommodation chamber to an outside of the housing.

19. The pedal device according to claim 18, wherein the elastic member is a spring that expands and contracts with an elastic deformation in a predetermined direction that is oblique to a horizontal direction in a state where the pedal, the elastic member, and the housing are installed in a vehicle.

20. A pedal device comprising:
a pedal;
an elastic member that is elastically deformed by a force applied by the pedal associated with displacement of the pedal, to apply an elastic force to the pedal as a reaction force against the force; and
a housing that defines an accommodation chamber in which the elastic member is accommodated,
wherein the elastic member is supported by the housing while being accommodated in the accommodation chamber and includes at least one passage that allows foreign matter to pass from an inside of the accommodation chamber to an outside of the accommodation chamber.

21. The pedal device according to claim 20, wherein
the at least one passage is made to discharge the foreign matter from an outlet to the outside of the accommodation chamber; and
the at least one passage is provided to extend downward toward the outlet in a state where the pedal, the elastic member, and the housing are installed in a vehicle.

22. A pedal device comprising:
a pedal;
an elastic member that is elastically deformed by a force applied by the pedal associated with a displacement of the pedal, to apply an elastic force to the pedal; and
a housing that defines an accommodation chamber in which the elastic member is accommodated, wherein
the elastic member is supported by the housing while being accommodated in the accommodation chamber, and
the housing includes at least one passage that allows foreign matter to pass from an inside of the accommodation chamber to an outside of the accommodation chamber.

23. The pedal device according to claim 22, wherein
the at least one passage includes an outlet that discharges the foreign matter, and
the at least one passage is provided to extend downward as approaching the outlet in a state where the pedal, the elastic member, and the housing are installed in a vehicle.

24. A pedal device comprising:
a pedal;
an elastic member that is elastically deformed by a force applied by the pedal associated with displacement of the pedal, to apply an elastic force to the pedal as a reaction force against the force; and
a housing that defines an accommodation chamber in which the elastic member is accommodated, wherein
the elastic member is supported by the housing while being accommodated in the accommodation chamber, and
the elastic member is provided with at least one passage that is provided to penetrate the elastic member and to allow foreign matter to pass.
